(19) United States
(12) Patent Application Publication
(10) Pub. No.: US 2018/0376343 A1
(43) Pub. Date: Dec. 27, 2018

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/064,417

(22) PCT Filed: Dec. 22, 2016
(86) PCT No.: PCT/JP2016/088275

§ 371 Date: Jun. 20, 2018

(30) Foreign Application Priority Data
Dec. 25, 2015 (JP) 2015-255284

(51) Int. Cl. H04W 16/14; H04W 24/10; H04L 5/00; H04W 74/08; H04W 72/04; H04W 4/06

(52) U.S. Cl. CPC H04W 16/14; H04W 24/10; H04L 5/0048; H04W 4/06; H04W 74/0808; H04W 72/0406; H04W 72/0466; H04L 5/0053

(57) ABSTRACT

The present invention is designed so that it is possible to improve the characteristics of communication in cells where listening is executed before transmission (for example, unlicensed band cells). According to one aspect of the present invention, a user terminal, in a cell in which listening is performed before transmission, has a transmission section that transmits channel state information (CSI), and a measurement section that measures the CSI in a measurement subframe by using a measurement reference signal. The measurement subframe is defined as a subframe in which the CSI can be measured and is at least one of a Multimedia Broadcast Multicast Service (MBMS) Single Frequency Network (MBSFN) subframe, a partial subframe consisting of part of symbols, and a transmission subframe of a detection signal, other than subframe index #0 or #5, which coincides with a transmission subframe of a channel state information reference signal (CSI-RS).

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, the specifications of LTE-A (also referred to as LTE-advanced, LTE Rel. 10, 11 or 12) have been drafted for further broadbandization and increased speed beyond LTE (also referred to as LTE Rel. 8 or 9), and successor systems of LTE (also referred to as, for example, FRA (Future Radio Access), 5G (5th generation mobile communication system), LTE Rel. 13 and so on) are under study.

The specifications of Rel. 8 to 12 LTE have been drafted assuming exclusive operations in frequency bands that are licensed to operators—that is, licensed bands. As licensed bands, for example, 800 MHz, 1.7 GHz and 2 GHz are used.

In recent years, user traffic has been increasing steeply following the spread of high-performance user terminals (UE: User Equipment) such as smart-phones and tablets. Although more frequency bands need to be added to meet this increasing user traffic, licensed bands have limited spectra (licensed spectra).

Consequently, a study is in progress with Rel. 13 LTE to enhance the frequencies of LTE systems by using bands of unlicensed spectra (also referred to as “unlicensed bands”) that are available for use apart from licensed bands (see non-patent literature 2). For unlicensed bands, for example, the 2.4 GHz band and the 5 GHz band, where Wi-Fi (registered trademark) and Bluetooth (registered trademark) can be used, are under study for use.

To be more specific, with Rel. 13 LTE, a study is in progress to execute carrier aggregation (CA) between licensed bands and unlicensed bands. Communication that is carried out by using unlicensed bands with licensed bands like this is referred to as “LAA” (License-Assisted Access). Note that, in the future, dual connectivity (DC) between licensed bands and unlicensed bands and stand-alone in unlicensed bands may become the subject of study under LAA.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”
Non-Patent Literature 2: AT&T, Drivers, Benefits and Challenges for LTE in Unlicensed Spectrum, 3GPP TSG-RAN Meeting #62 RP-131701

### SUMMARY OF INVENTION

### Technical Problem

In unlicensed band cells, the measurement subframes (CSI reference resources) that can be used to measure channel state information (CSI) are limited in order to simplify the operations and specifications of user terminals. Therefore, CSI that is reported to the radio base station tends to be old, and, if communication is controlled (for example, transmission control of a downlink shared channel (PDSCH: Physical Downlink Shared Channel)) based on such CSI, the characteristics of communication (for example, spectral efficiency) in unlicensed band cells may be deteriorated as compared with communication in the license band cells.

The present invention has been made in view of the above, and it is therefore an object of the present invention to provide a user terminal, a radio base station and a radio communication method that can improve the characteristics of communication in cells where listening is executed prior to transmission (for example, unlicensed band cells).

### Solution to Problem

A user terminal according to an aspect of the present invention is a user terminal, in a cell in which listening is performed before transmission, having a transmission section that transmits channel state information (CSI), and a measurement section that measures the CSI in a measurement subframe by using a measurement reference signal, and the measurement subframe is defined as a subframe in which the CSI can be measured and is at least one of a Multimedia Broadcast Multicast Service (MBMS) Single Frequency Network (MBSFN) subframe, a partial subframe consisting of part of symbols, and a transmission subframe of a detection signal, other than subframe index #0 or #5, which coincides with a transmission subframe of a channel state information reference signal (CSI-RS).

### Advantageous Effects of Invention

According to the present invention, it is possible to improve the characteristics of communication in cells where listening is executed before transmission (for example, unlicensed band cells).

### BRIEF DESCRIPTION OF DRAWINGS

FIGS. 1A and 1B provide diagrams to show examples of LAA DRS configurations;

FIGS. 2A and 2B are diagrams to show examples of CSI measurement and reporting in unlicensed bands;

FIG. 3 is a diagram to show an example of CRS-based CSI measurement according to the first example;

FIG. 4 is a diagram to show an example of CSI-RS-based CSI measurement according to the first example;

FIG. 5A and FIG. 5B are diagrams to show examples of CSI-RS-based CSI measurement according to a second example;

FIGS. 6A and 6B are diagrams to show examples of rules applied to CSI-RS transmission according to the second example;

FIGS. 7A and 7B are diagrams to show other examples of rules applied to CSI-RS transmission according to the second example;

FIG. 8 provide diagrams to show examples of UL transmission according to a third example;

FIGS. 9A to 9C are diagrams to show examples of configurations of additional symbols including the CSI-RS according to the third example;

FIGS. 10A and 10B are diagrams to explain CSI-RS resources;

FIG. 11 is a diagram to show an example of a schematic structure of a radio communication system according to the present embodiment;

FIG. 12 is a diagram to show an example of an overall structure of a radio base station according to the present embodiment;

FIG. 13 is a diagram to show an example of a functional structure of a radio base station according to the present embodiment;

FIG. 14 is a diagram to show an example of an overall structure of a user terminal according to the present embodiment:

FIG. 15 is a diagram to show an example of a functional structure of a user terminal according to the present embodiment; and

FIG. 16 is a diagram to show an example hardware structure of a radio base station and a user terminal according to the present embodiment.

### DESCRIPTION OF EMBODIMENTS

As mentioned earlier, in systems that run LTE/LTE-A in unlicensed bands (for example, LAA systems), interference control functionality is likely to be necessary in order to allow co-presence with other operators' LTE, Wi-Fi, or other different systems. Note that systems that run LTE/LTE-A in unlicensed bands may be collectively referred to as “LAA.” “LAA-LTE,” “LTE-U,” “U-LTE” and so on, regardless of whether the mode of operation is CA, DC or SA.

Generally speaking, when a transmission point (for example, a radio base station (eNB), a user terminal (UE) and so on) that communicates by using a carrier (which may also be referred to as a “carrier frequency,” or simply a “frequency”) of an unlicensed band detects another entity (for example, another user terminal) that is communicating in this unlicensed band carrier, the transmission point is disallowed to make transmission in this carrier.

Therefore, the transmission point performs listening (LBT: Listen Before Talk) at a timing a predetermined period ahead of a transmission timing. To be more specific, by executing LBT, the transmission point searches the whole of the target carrier band (for example, one component carrier (CC)) at a timing that is a predetermined period ahead of a transmission timing, and checks whether or not other devices (for example, radio base stations, user terminals, Wi-Fi devices and so on) are communicating in this carrier band.

Note that, in the present description, “listening” refers to the operation which a given transmission point (for example, a radio base station, a user terminal, etc.) performs before transmitting signals in order to check whether or not signals to exceed a predetermined level (for example, predetermined power) are being transmitted from other transmission points. Further, the listening performed by radio base stations and/or user terminals may be referred to as “LBT,” “CCA” (Clear Channel Assessment), “carrier sensing,” or the like.

The transmission point then carries out transmission using this carrier only if it is confirmed that no other devices are communicating. If the received power measured during LBT (the received signal power during the LBT period) is equal to or lower than a predetermined threshold, the transmission point judges that the channel is in the idle state (LBTidle), and carries out transmission. When a “channel is in the idle state,” this means that, in other words, the channel is not occupied by a specific system, and it is equally possible to say that a channel is “idle,” a channel is “clear,” a channel is “free,” and so on.

On the other hand, if only just a portion of the target carrier band is detected to be used by another device, the transmission point stops its transmission. For example, if the transmission point detects that the received power of a signal from another device entering this band exceeds a threshold, the transmission point judges the channel is in the busy state (LBT_{busy}), and makes no transmission. In the event LBT_{busy} is yielded, LBT is carried out again with respect to this channel, and the channel becomes available for use only after it is confirmed that the channel is in the idle state. Note that the method of judging whether a channel is in the idle state/busy state based on LBT is by no means limited to this.

As LBT mechanisms (schemes), FBE (Frame Based Equipment) and LBE (Load Based Equipment) are currently under study. Differences between these include the frame configurations to use for transmission/receipt, the channel-occupying time, and so on. In FBE, the LBT-related transmitting/receiving configurations have fixed timings. Also, in LBE, the LBT-related transmitting/receiving configurations are not fixed in the time direction, and LBT is carried out on an as-needed basis.

To be more specific, FBE has a fixed frame cycle, and is a mechanism of carrying out transmission if the result of executing carrier sensing for a certain period (which may be referred to as “LBT duration” and so on) in a predetermined frame shows that a channel is available for use, and not making transmission but waiting until the next carrier sensing timing if no channel is available.

On the other hand, LBE refers to a mechanism for implementing the ECCA (Extended CCA) procedure of extending the duration of carrier sensing when the result of carrier sensing (initial CCA) shows that no channel is available for use, and continuing executing carrier sensing until a channel is available. In LBE, random backoff is required to adequately avoid contention.

Note that the duration of carrier sensing (also referred to as the “carrier sensing period”) refers to the time (for example, the duration of one symbol) it takes to gain one LBT result by performing listening and/or other processes and deciding whether or not a channel can be used.

A transmission point can transmit a predetermined signal (for example, a channel reservation signal) based on the result of LBT. Here, the result of LBT refers to information about the state of channel availability (for example, “LBT_{idle},” “LBT_{busy},” etc.), which is acquired by LBT in carriers where LBT is configured.

Also, when a transmission point starts transmission when the LBT result shows the idle state (LBT_{idle}), the transmission point can skip LBT and carry out transmission for a predetermined period (for example, for 10 to 13 ms). This transmission is also referred to as “burst transmission,” “burst,” “transmission burst,” and so on.

As described above, by introducing interference control that is based on LBT mechanism and that is for use within the same frequency to transmission points in LAA systems, it becomes possible to prevent interference between LAA and Wi-Fi, interference between LAA systems and so on. Furthermore, even when transmission points are controlled independently per operator that runs an LAA system, LBT makes it possible to reduce interference without learning the details of each operator's control.

In addition, in LAA system, when SCells (Secondary Cells) of unlicensed bands are configured or re-configured in a user terminal, the user terminal has to perform RRM (Radio Resource Management) measurements (including RSRP (Reference Signal Received Power) measurements, etc.) to detect the SCells existing in the surroundings, measure the received quality, and send a report to the network. The signal to allow RRM measurement in LAA is under study based on the discovery reference signal (DRS) stipulated in Rel. 12.

Note that the signal for RRM measurement in LAA may be referred to as the “detection/measurement signal,” the “discovery reference signal” (DRS), the “discovery signal” (DS), the “LAA DRS,” the “LAA DS.” and so on. Also, an unlicensed band SCell may be referred to as, for example, an “LAA SCell.”

Similar to the Rel. 12 DRS, a study is in progress to constitute the LAA DRS by including at least one of synchronization signals (PSS (Primary Synchronization Signal)/SSS (Secondary Synchronization Signal)), a cell-specific reference signal (CRS) and a channel state information reference signal (CSI-RS).

Also, the network (for example, radio base stations) can configure the DMTC (Discovery Measurement Timing Configuration) of the DRS in user terminals per frequency. The DMTC contains information about the transmission cycle of the DRS (which may be also referred to as “DMTC periodicity” and so on), DRS measurement timing offsets, and so on.

The DRS is transmitted per DMTC periodicity, in the DMTC duration. Here, according to Rel. 12, the DMTC duration is fixed to 6 ms. Also, the length of the DRS (which may be also referred to as the “DRS occasion,” the “DS occasion,” the “DRS burst,” the “IDS burst” and so on) that is transmitted in the DMTC duration is between 1 ms and 5 ms. The LAA DRS may be configured the same as in Rel. 12, or may be configured differently. For example, taking the time of LBT into account, the DRS occasion may be made 1 ms or shorter, or may be made 1 ms or greater.

In an unlicensed band cell, a radio base station executes listening (LBT) before transmitting the LAA DRS, and transmits the LAA DRS when LBT_{idle} is yielded. A user terminal learns the timings and the cycle of DRS occasions based on the DMTC reported from the network, and detects and/or measures the DRS.

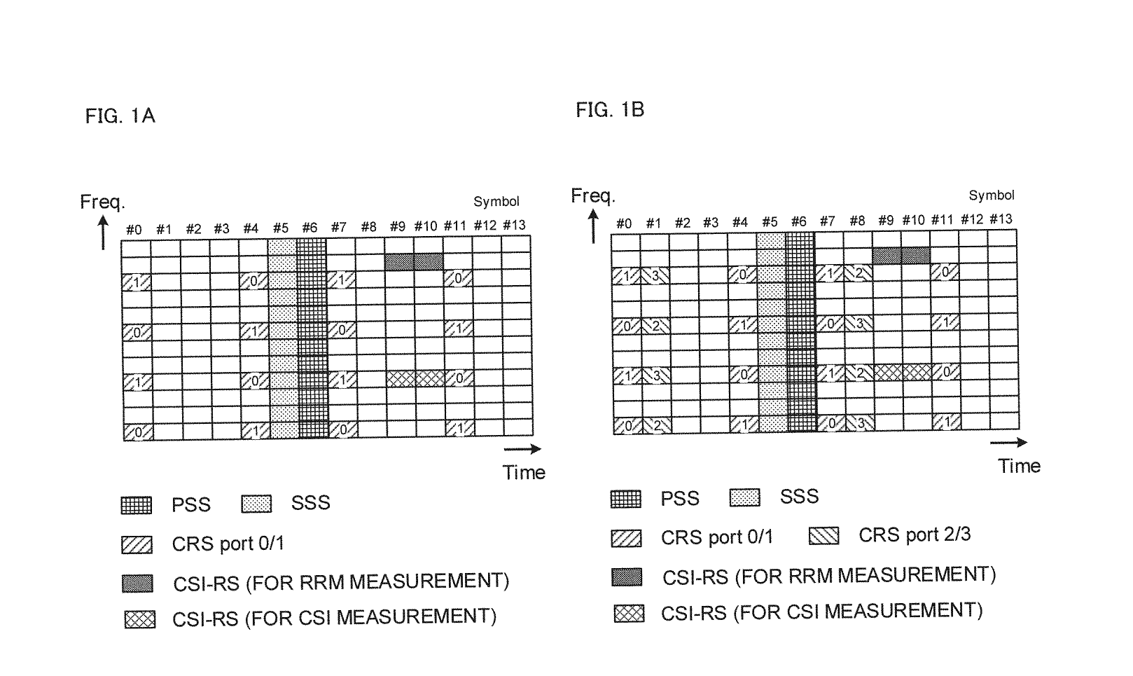

FIG. 1 provide diagrams that show examples of LAA DRS configurations. FIG. 1A shows an example configuration for use when CRSs are transmitted by using two antenna ports. In FIG. 1A, the DRS is formed by including CRSs (port 0/1) in symbols #0, #4, #7 and #11, a PSS in symbol #6 and an SSS in symbol #5. The DRS may be configured to include CSI-RSs, which are configured for RRM measurements. Note that, in FIG. 1A, CSI-RSs for RRM measurement are arranged in symbols #9 and #10, but this is by no means limiting. FIG. 1B shows an example configuration for use when CRSs are transmitted by using four antenna ports. The DRS of FIG. 1B is formed to include CRSs (port 2/3) in symbols #1 and #8, on top of the configuration of FIG. 1A.

Also, when the CSI-RS transmission subframe for CSI measurement, which is configured in a predetermined cycle (for example, a minimum of 5 ms), matches the DRS transmission subframe in the DMTC duration that is configured in the DMTC periodicity (for example, a minimum of 40 ms), as shown in FIGS. 1A and 1B, a CSI-RS for CSI measurement may be placed in the DRS transmission subframe apart from the CSI-RS for RRM measurement. In this case, the user terminal can measure CSI using the CSI-RS for CSI measurement in the DRS transmission subframe. Note that if the CSI-RS transmission subframe of a predetermined cycle and the DRS transmission subframe do not match, no CSI-RS for CSI measurement is placed in the DRS transmission subframe.

Note that, in FIGS. 1A and 1B, a “CRS port X” indicates a CRS that is transmitted using an antenna port X. Also, the LAA DRS configurations shown in FIGS. 1A and 1B are simply examples, and these are by no means limiting. An LAA DRS has only to be formed by including at least one of a synchronization signal (PSS/SSS), a CRS and a CSI-RS. Also, the locations (for example, resource elements) to allocate the PSS/SSS. CRSs and CSI-RSs may be the same as in existing systems (for example, Rel. 12), or may be different. Furthermore, an LAA DRS may be formed by using 12 symbols of the Rel. 12 DRS (for example, symbols #0 to #11).

By the way, in unlicensed band cells, CSI is measured using the CRS and/or the CSI-RSs (hereinafter “CRS/CSI-RS”), and the measurement result is reported to the radio base station (CSI reporting). Note that, the CRS may be the CRS included in each subframe in which downlink transmission is performed, or may be the CRS that constitutes the DRS (see FIGS. 1A and 1B, for example). Further, the CRI-RSs may be a CSI-RS for CSI measurement, configured in a predetermined cycle (for example, 5 ms, 10 ms, etc.), or the CSI-RS may be a CSI-RS for CSI measurement, arranged in the DRS transmission subframe when the CSI-RS transmission subframe for CSI measurement and the DRS transmission subframe match.

Whether to measure CSI by using the CRS or the CSI-RS may be reported to the user terminal by higher layer signaling (for example, RRC (Radio Resource Control) signaling, system information, etc.), or this may be determined by the user terminal based on the transmission mode of a downlink shared channel (PDSCH: Physical Downlink Shared CHannel). In addition, CSI reporting based on the CRS/CSI-RS may be aperiodic CSI reporting or periodic CSI reporting.

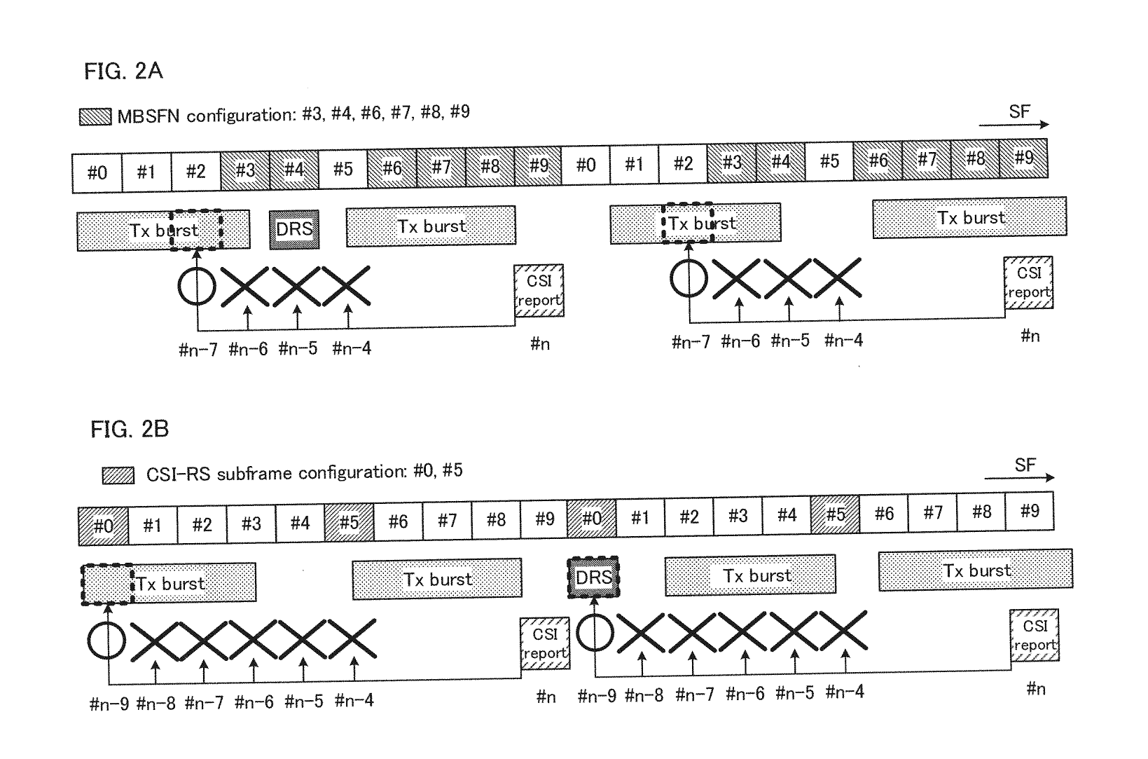

FIG. 2 show examples of CSI measurement and reporting in unlicensed bands. FIG. 2A shows CRS-based CSI measurement. In FIG. 2A, the user terminal measures CSI based on the CRS in measurement subframe #n-n_{CQI}_{_}_{ref}. Here, measurement subframe #n-n_{CQI}_{_}_{ref} is the nearest subframe satisfying the following condition 1 predetermined time X or more before CSI transmission subframe #n (n_{CQI}_{_}_{ref}≥X). Measurement subframe #n-n_{CQI}_{_}_{ref} may also be referred to as “CSI reference resource.”

<Condition 1>
There is downlink transmission in a serving cell (unlicensed band cell); and
The measurement subframe is not an MBSFN (Multimedia Broadcast Multicast Service (MBMS) Single Frequency Network); and
The measurement subframe is not a partial subframe; and
The CRS scrambling sequence is based on (“follows”) the (actual) subframe index.

Here, whether or not there is downlink transmission in a serving cell is judged by whether or not the CRS of the serving cell is transmitted in the first symbol of the subframe.

Further, an MBSFN subframe refers to a subframe in which the CRS is placed only in one or two symbols at the head of the subframe. In normal subframes, the CRS is allocated to four symbols when two antenna ports are used and to six symbols when four antenna ports are used (see FIGS. 1A and 1B). On the other hand, in MBSFN subframes, the CRS is allocated only to the first one OFDM symbol when two antenna ports are used and to the first and second two OFDM symbols when four antenna ports are used.

By using MBSFN subframes, the CRS overhead can be reduced in transmission modes (for example, transmission modes 7-10) for demodulating a downlink shared channel (PDSCH: Physical Downlink Shared CHannel) using a demodulation reference signal (DMRS). Which subframes in a radio frame are MBSFN subframes (MBSFN configuration) is signaled by higher layer (for example, RRC (Radio Resource Control), system information, etc.).

Note that, maximum eight subframes in a radio frame, excluding subframes #0 and #5, can be configured as MBSFN subframes. Further, the DRS may be transmitted in either normal subframes or MBSFN subframes. Also, MBSFN subframes do not apply to partial subframes.

Further, a partial subframe is a subframe with fewer symbols than a full subframe. A full subframe has a time duration of one ms and is also referred to as a “transmission time interval” (TTI). A full subframe is comprised of 14 symbols, for example, when a normal cyclic prefix (CP) is applied to each symbol, and is comprised of 12 symbols when an enhanced CP is applied.

Since a partial subframe has fewer symbols than a full subframe, cases might occur where enough CRSs are not included. In addition, partial subframes are stipulated not to transmit CSI-RSs. Therefore, partial subframes are not regarded as CSI reference resources (valid subframes). Note that, the partial subframe provided at the beginning of a transmission burst is referred to as a “starting partial subframe,” an “initial partial subframe” and so on, and the partial subframe provided at the end of a transmission burst is referred to as an “ending partial subframe,” an “end partial subframe” and so on.

Further, a subframe in which the CRS scrambling sequence does not follow the actual subframe index is a subframe in which the DRS is transmitted, other than subframe #0 or #5. The scrambling sequence of a CRS constituting the DRS follows subframe index #0 when the DRS is transmitted in subframes #0 to #4, and follows subframe index #5 when the DRS is transmitted in subframes #5 to #9.

Therefore, when the DRS is transmitted in subframes other than subframes #0 and #5, the CRS scrambling sequence is generated based on subframe index #0 or #5, and does not follow the actual subframe index. In this case, the scrambling sequence of the CSI-RS for RRM measurement, making up the DRS, is also generated based on subframe index #0 or #5, and does not follow the actual subframe index. Meanwhile, the scrambling sequence of the CSI-RS for CSI measurement, included in this DRS transmission subframe, follows the actual subframe index.

For example, suppose that, in FIG. 2A, subframe #9 is CSI reporting subframe #n, and the above-mentioned predetermined time X is four. Further, in FIG. 2A, it is assumed that subframes #3, #4, #6, #7, #8 and #9 are configured as MBSFN subframes.

In FIG. 2A, subframe #n-4 (#5) on the left side is a partial subframe and therefore does not satisfy above condition 1. The DRS is transmitted in subframe #n-5 (#4), and the scrambling sequence of the CRS in the DRS follows subframe index #0, and does not follow actual subframe index #4. Therefore, subframe #n-5 (#4) does not satisfy above condition 1. Also, subframe #n-6 (#3) is a partial subframe and therefore does not satisfy above condition 1.

Meanwhile, in subframe #n-7 (#2) on the left side in FIG. 2A, there is downlink transmission in the serving cell, and the subframe is not an MBSFN subframe and is not a partial subframe. Also, in subframe #n-7 (#2), since the DRS is not transmitted, the CRS scrambling sequence follows actual subframe index #2 and satisfies above condition 1. Therefore, in subframe #n-7 (#2) that satisfies condition 1, the user terminal measures CSI based on the CRS.

Furthermore, in FIG. 2A, in subframe #n-4 (#5) on the right side, since downlink transmission is not made in the serving cell, above condition 1 is not satisfied. Also, subframe #n-5 (#4) is a partial subframe and therefore does not satisfy above condition 1. Also, since subframe #n-6 (#3) is an MBSFN subframe, it does not satisfy above condition 1. Subframe #n-7 (#2) satisfies condition 1 above, and so CSI is measured based on the CRS in subframe #n-7 (#2).

In FIG. 2B, CSI-RS-based CSI measurement is shown. In FIG. 2B, the user terminal measures CSI based on the CSI-RS in measurement subframe #n-n_{CQI}_{_}_{ref}. Here, measurement subframe #n-n_{CQI}_{_}_{ref} is the nearest subframe that satisfies the following condition 2 predetermined time X or more before CSI transmission subframe #n (n_{CQI}_{_}_{ref}≥X).

<Condition 2>
There is downlink transmission in a serving cell (unlicensed band cell); and
The measurement subframe is not a subframe in which CSI-RS transmission is configured; and
The measurement subframe is not a partial subframe; and
The CRS scrambling sequence is based on (“follows”) the (actual) subframe index.

For example, in FIG. 2B, subframe #9 is CSI reporting subframe #n, and the predetermined time X is four. In addition, in FIG. 2B, CSI-RS transmission of a 5-ms cycle is configured in subframes #0 and #5 by high layer signaling.

In FIG. 2B, subframe #n-4 (#5) on the left side is a partial subframe and therefore does not satisfy above condition 2. Also, since downlink transmission is not made in the serving cell in subframe #n-5 (#4), above condition 2 is not satisfied. Also, since subframe #n-6 (#3) is a partial subframe, above condition 2 is not satisfied. Also, in subframes #n-7 (#2) and #n-8 (#1), CSI-RS transmission is not configured, and so above condition 2 is not satisfied.

Meanwhile, in subframe #n-9 (#0), there is downlink transmission in the serving cell and CSI-RS transmission is configured, and the subframe is not a partial subframe. Furthermore, since the DRS is not transmitted in subframe #n-9 (#0), the CRS scrambling sequence follows actual subframe index #0. Accordingly, subframe #n-9 (#0) on the left side in FIG. 2B satisfies above condition 2, and the user terminal measures CSI based on the CSI-RS in subframe #n-9 (#0). In subframe #0 or #5, even if the DRS is transmitted, the CRS scrambling sequence coincides with actual subframe index #0 or #5, and so the CRS scrambling sequence follows the actual subframe index.

Also, in FIG. 2B, subframe #n-4 (#5) on the right side is a partial subframe and therefore does not satisfy above condition 2. Also, in subframes #n-5 (#4) to #n-7 (#2), CSI-RS transmission is not configured, and so above condition 2 is not satisfied. Further, in subframe #n-8 (#1), since downlink transmission is not made in the serving cell, and therefore above condition 2 is not satisfied.

Meanwhile, in subframe #n-9 (#0), there is downlink transmission in the serving cell and CSI-RS transmission is configured, and the subframe is not a partial subframe. Also, although the DRS is transmitted in subframe #n-9 (#0), since the actual subframe index is also #0 as described above, the CRS scrambling sequence in the DRS following actual subframe index #0. Therefore, subframe #n-9 (#0) on the right side in FIG. 2B satisfies above condition 2, and the user terminal measures CSI based on the CSI-RS in subframe #n-9 (#0).

In FIG. 2B, when the DRS is transmitted in subframes other than subframe #0 or #5, the CRS scrambling sequence in the DRS does not follow the actual subframe index. Therefore, unless the CSI-RS transmission subframe of a predetermined cycle is configured in subframe #0 and/or #5, even if the CSI-RS transmission subframe and the DRS transmission subframe match, it is not possible to measure CSI using the CSI-RS for CSI measurement included in the DRS transmission subframe.

In this way, when an attempt is made to make it possible to measure CSI based on CSI-RSs for CSI measurement included in DRS transmission subframes, the CSI-RS transmission subframe of a predetermined cycle (a 5-ms or a 10-ms cycle) is limited to subframe #0 and/or #5, and therefore the CSI-RS transmission subframe of a predetermined cycle cannot be configured flexibly. That is, it is not possible to configure the timings of periodic CSI measurement and reporting flexibly.

Furthermore, given that the subframes satisfying above condition 2 are limited to subframes #0 and #5, when trying to measure CSI (fresh CSI) based on the CSI-RS in a subframe as close as possible to the reporting timing (subframe #n) (for example, subframe #n-4 in FIG. 2B), aperiodic CSI is triggered in many user terminals at the same timing. As a result of this, there is a threat that many user terminals report CSI at the same timing, and the uplink (UL) overhead may increase.

As described above, in unlicensed band cells, in order to simplify the operations and specifications of user terminals, measurement subframes (CSI reference resources), in which CSI can be measured, are defined in a limited manner. Therefore, in unlicensed band cells, CSI that is reported to the radio base station tends to be old, and there is a possibility that communication control cannot be appropriately performed based on such CSI. Especially, in closed-loop transmission mode (for example, transmission mode 4, 6 or 9), in which PDSCH layer (rank) control (control of space-multiplexing) is performed based on CSI, the communication characteristics (for example, spectral efficiency) in unlicensed band cells may be deteriorated significantly compared with the communication characteristics in license band cells.

Therefore, the present inventors have come up with an idea of improving communication characteristics in unlicensed band cells (for example, spectral efficiency) by enabling CSI measurement in subframes as close as possible to reporting timings in unlicensed band cells.

To be more specific, the present inventors have come up with ideas of changing the definition of measurement subframes in which CSI can be measured (first example), stipulating new listing for making one-ms or shorter downlink transmission not including the PDSCH (for example, CSI-RS transmission) (second example), and transmitting the measurement reference signal in partial subframes while maintaining backward compatibility with existing user terminals (for example, Rel. 13 UE) (third example).

Now, embodiments of the present invention will be described below in detail with reference to the accompanying drawings. Although the following embodiment will be described assuming that a carrier (cell) where listening is configured is an unlicensed band, this is by no means limiting. The present embodiment is applicable to any carriers (or cells) in which listening is configured, regardless of whether this carrier is a licensed band or an unlicensed band.

Also, although a case will be assumed with the present embodiment where CA or DC is applied between a carrier in which listening is not configured (for example, the primary cell (PCell) of a licensed band) and a carrier in which listening is configured (for example, a secondary cell (SCell) of an unlicensed band), this is by no means limiting. For example, the present embodiment is applicable to cases where a user terminal connects with a carrier (cell) in which listening is configured in stand-alone.

### First Example

In the first example, a user terminal in a cell (for example, an unlicensed band cell) in which listening is performed before transmission measures CSI using a measurement reference signal in a measurement subframe and transmits the CSI.

Here, the measurement subframe is defined so that CSI can be measured based on at least one of an MBSFN subframe, a partial subframe and a DRS (detection signal) transmission subframe, other than subframe index #0 or #5, which coincides with the CSI-RS transmission subframe. Note that, when distinguishing from the measurement subframe (CSI reference resource) based on the above conditions 1 or 2, the measurement subframe may be referred to as “enhanced CSI reference resource” or the like.

Furthermore, the measurement reference signal may be either the CRS or the CSI-RS, may be the CSI-RS for CSI measurement included in the transmission subframe of the DRS or the CRS constituting the DRS, or may be another reference signal. Note that CSI-RS-based CSI measurement may be applied to user terminals in which transmission mode 9 (spatial multiplexing of up to eight layers) or transmission mode 10 (CoMP (Coordinated Multi-Point) transmission) is configured.

<CRS-Based CSI Measurement>

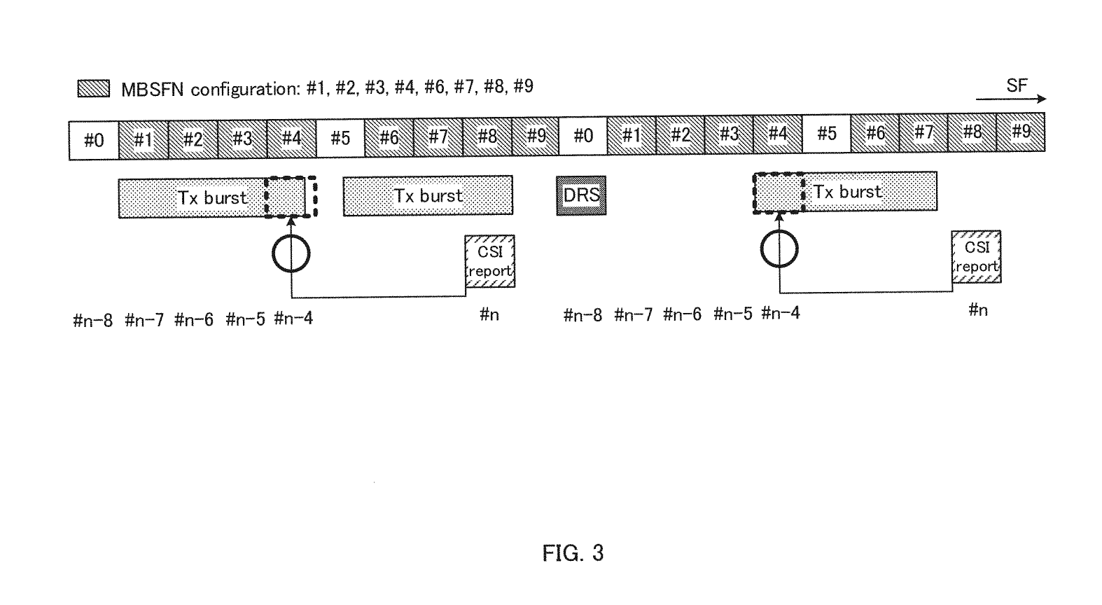

FIG. 3 is a diagram to show an example of CRS-based CSI measurement according to the first example. In FIG. 3, the user terminal measures CSI based on the CRS in measurement subframe #n-n_{CQI}_{_}_{ref}. Here, measurement subframe #n-n_{CQI}_{_}_{ref} is the nearest subframe satisfying the following condition 3 predetermined time X (nCQI_ref≥X) or more before CSI transmission subframe #n. The condition 3 is merely an example, and this is by no means limiting

<Condition 3>
There is downlink transmission in the serving cell; and
The CRS scrambling sequence follows the (actual) subframe index.

For example, in FIG. 3, it is assumed that subframe #8 is CSI transmission subframe #n, and predetermined time X is four. Further, in FIG. 3, it is assumed that subframes #1, #2, #3, #4, #6, #7, #8 and #9 are configured as MBSFN subframes.

In FIG. 3, in subframe #n-4 (#4) on the right side, there is downlink transmission in the serving cell. Also, in subframe #n-4 (#4), since the DRS is not transmitted, the CRS scrambling sequence follows actual subframe index #4. Since subframe #n-4 (#4) satisfies condition 3, the user terminal measures CSI using the CRS included in subframe #n-4 (#4).

Here, subframe #n-4 (#4) on the right side is the MBSFN subframe at the head of the transmission burst. As mentioned earlier, since, in MBSFN subframes, the CRS is placed only in the first one or two symbols, the accuracy of CSI may be deteriorated. However, the user terminal can assume that the transmission power of the CRS in subframes #4 to #7 in this transmission burst is constant (note that it cannot be assumed that the transmission power of the CRS is the same between transmission bursts). Therefore, by averaging the CSI measurement results in subframes in the transmission burst, the accuracy of CSI can be guaranteed, and it becomes possible to use the CSI measured in the MBSFN subframe at the head of the transmission burst.

In FIG. 3, subframes #n-5 (#4) to #n-7 (#1) are MBSFN subframes, and, when the above existing condition 1 is applied, the CSI to be reported in subframe #n on the right side is measured using the CRS in the DRS transmitted in subframe #n-8 (#0). On the other hand, as mentioned earlier, since condition 3 is satisfied in subframe #n-4 (#4), so that, by using condition 3, it is possible to measure CSI in a subframe that is closer to the reporting timing as compared with the case where existing condition 1 is used.

Further, in subframe #n-4 (#4) on the left side, there is downlink transmission in the serving cell. Since the DRS is not transmitted, in subframe #n-4 (#4) on the left side, the CRS scrambling sequence follows actual subframe index #4. Since subframe #n-4 (#4) satisfies condition 3, the user terminal measures CSI using the CRS included in subframe #n-4 (#4).

Here, subframe #n-4 (#4) on the left side is a partial subframe. In FIG. 3 it is assumed that subframe #4 is configured as an MBSFN subframe, but it is likely that an MBSFN subframe does not apply to a partial subframe. Therefore, if symbols to arrange the CRS are sufficiently included in the partial subframe (for example, if four or six symbols are included), it is possible to use CSI that is measured using the CRS in this partial subframe.

In FIG. 3, since subframe #n-4 (#4) on the left side is a partial subframe and subframes #n-5 (#3) to #n-7 (#1) are MBSFN subframes, if existing condition 1 is used, the CSI to be reported in subframe #n on the left side is measured in a subframe before subframe #0 on the left side. Meanwhile, as mentioned earlier, since condition 3 is satisfied in subframe #n-4 (#4), it is possible to measure CSI, by using condition 3, in a subframe closer to the reporting timing.

In the example shown in FIG. 3, CSI is measured based on the CRS in the last partial subframe in a transmission burst, but the user terminal may perform CRS-based CSI measurement in the first partial subframe of the transmission burst as well.

<CSI-RS-Based CSI Measurement>

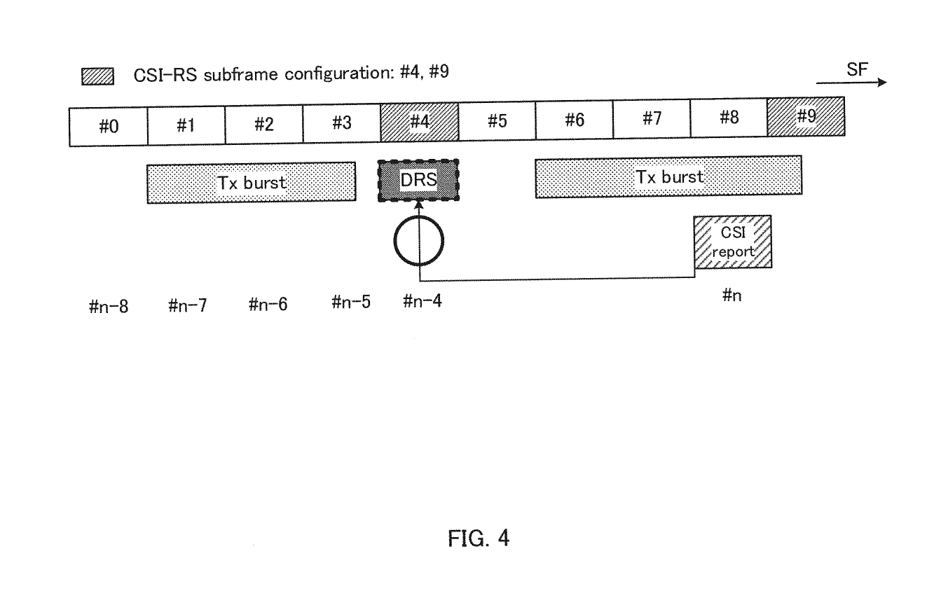

FIG. 4 is a diagram to show an example of CSI-RS-based CSI measurement according to the first example. In FIG. 4, the user terminal measures CSI based on the CSI-RS in measurement subframe #n-n_{CQI}_{_}_{ref}. Here, measurement subframe #n-n_{CQI}_{_}_{ref} is the nearest subframe satisfying following condition 4 predetermined time X or more before CSI transmission subframe #n (n_{CQI}_{_}_{ref}≥X). Condition 4 is merely an example, and this is by no means limiting.

<Condition 4>
There is downlink transmission in the serving cell; and
CSI-RS transmission of a predetermined cycle is configured; and
The subframe is not a partial subframe.

For example, in FIG. 4, suppose that subframe #8 is CSI transmission subframe #n and X is four. Further, in FIG. 4, it is assumed that CSI-RS transmission is configured in subframes #4 and #9 by high layer signaling.

In FIG. 4, in subframe #n-4 (#4), there is downlink transmission in the serving cell. Further, CSI-RS transmission of a predetermined cycle is configured in subframe #n-4 (#4). Also, subframe #n-4 (#4) is not a partial subframe. As described above, since subframe #n-4 (#4) satisfies condition 4, the user terminal measures CSI using the CSI-RS included in subframe #n-4 (#4).

Here, the DRS is transmitted in subframe #n-4 (#4). When the DRS is transmitted in subframes other than subframe #0 or #5, the CRS scrambling sequence does not follow the actual subframe index (#4), and there is a possibility that the downlink transmission in the serving cell cannot be recognized based on the CRS placed in the top symbol. Meanwhile, it is possible to recognize downlink transmission in the serving cell by detecting the CRS scrambling sequence based on the presence/absence of the PSS/SSS in the DRS and the rules applied to the scrambling sequence of the CRS in the DRS (#0 if the actual subframe index is #0 to #4, or #5 if the actual subframe index is #5 to #9).

Also, the scrambling sequence of the CSI-RS for CSI measurement in subframe #n-4 (#4) matches actual subframe index #4. Therefore, if downlink transmission in the serving cell can be recognized based on the presence/absence of the PSS/SSS and the rules applied to the scrambling sequence of the CRS in the DRS, it is possible to measure CSI using the CSI-RS for CSI measurement arranged in this subframe #n-4 (#4) and use this CSI.

Referring to FIG. 4, when existing condition 2 is used, in the subframe #n-4 (#4), the CRS scrambling sequence does not follow the actual subframe index (#4), subframe #n-5 (#3) is a partial subframe, and CSI-RS transmission is not configured in subframes #n-6 (#2) to #n-8 (#0), so that the CSI to be reported in #n is measured before subframe #0. On the other hand, as described above, condition 4 is satisfied in subframe #n-4 (#4), so that, by using condition 4. CSI can be measured in a subframe closer to the reporting timing as compared with the case where existing condition 2 is used.

<L1 signaling>

As described above, in the first example, the measurement subframe (enhanced CSI reference resource) is defined as the nearest subframe satisfying condition 3 or 4 that is predetermined time X or more before CSI transmission subframe #n. Therefore, the freshness of CSI reported in same subframe #n differs between a user terminal (for example, a UE of original Rel. 13 specifications) that measures CSI in an existing measurement subframe (for example, an existing CSI reference resource, which is the nearest subframe satisfying condition 1 or 2 predetermined time X or more before transmission subframe #n, and a user terminal (for example, a UE of Rel. 13 option or Rel. 14 specifications) that measures CSI in the above enhanced CSI resource. Therefore, it is desirable to optimize the scheduling according to the freshness of CSI.

Also, in unlicensed band cells, the transmission power of the CRS or the CSI-RS varies in every transmission burst. Therefore, if the radio base station cannot know in which transmission burst the CSI reported from the user terminal has been measured, there is a possibility that the radio base station is unable to perform appropriate scheduling.

Therefore, the user terminal may transmit capability information (the UE capability), indicating whether or not the user terminal is able to measure CSI in an enhanced CSI reference resource (the nearest subframe that satisfies condition 3 or 4 predetermined time X or more before CSI transmission subframe #n), to the radio base station. The capability information may be transmitted via higher layer signaling such as RRC signaling.

Alternatively, the user terminal may receive, from the radio base station, command information to command whether or not to measure CSI in the enhanced CSI reference resource (the nearest subframe satisfying condition 3 or 4 predetermined time X or more before CSI transmission subframe #n). The command information may be transmitted via higher layer signaling such as RRC signaling.

Thus, in the first example, whether CSI is measured in the user terminal by using an enhanced CSI reference resource or by using an existing CSI reference resource is signaled between the radio base station and the user terminal. Therefore, the radio base station can perform scheduling taking the freshness of CSI into consideration, and can improve the characteristics of communication (for example, spectral efficiency) in unlicensed band cells.

### Second Example

In a second example, listening for one-ms or shorter downlink transmission, not including the PDSCH (for example, CSI-RS transmission) is newly defined, so that it is possible to measure CSI using the CSI-RS in a subframe that is as close to reporting timing as possible.

Note that the second embodiment may be used alone or may be used in combination with the first embodiment. That is, the CSI measurement according to the second example may be performed in the enhanced CSI reference resource described in the first example, or in an existing CSI reference resource. Hereinafter, CSI-RS-based CSI measurement using enhanced CSI reference resources will be exemplified.

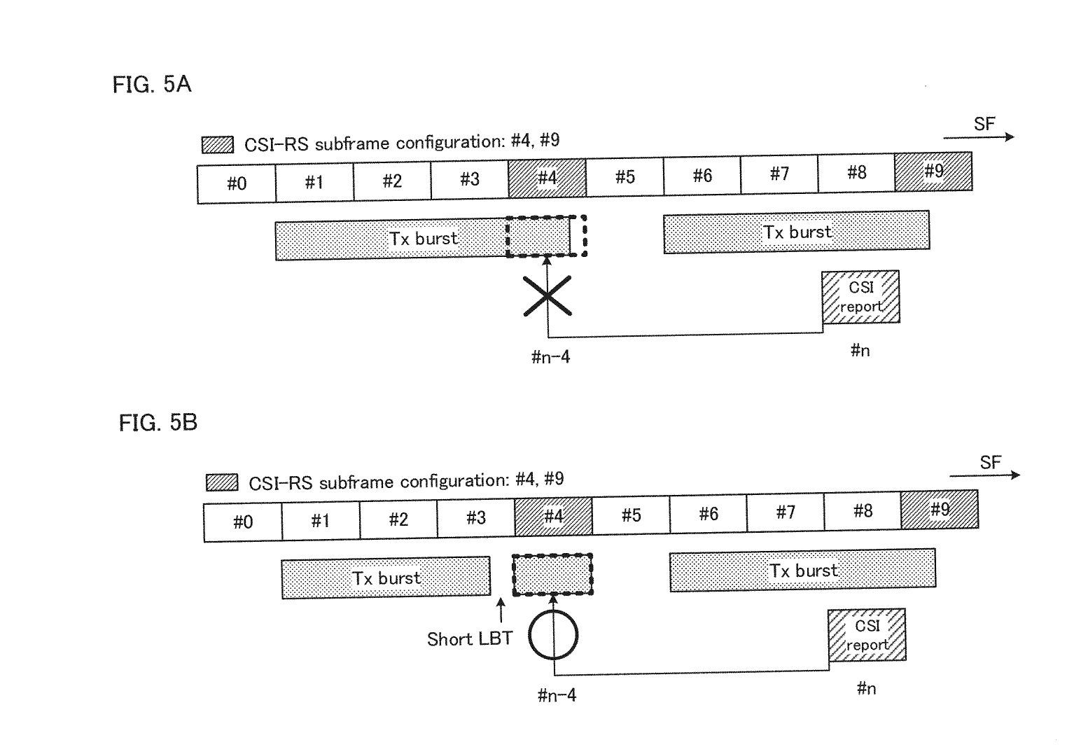

FIG. 5 is a diagram to show an example of CSI-RS-based CSI measurement according to the second example. In FIG. 5, the user terminal measures CSI based on the CSI-RS in the enhanced CSI reference resource (the nearest subframe satisfying condition 3 or 4 predetermined time X or more before CSI transmission subframe #n). For example, in FIG. 5, as in FIG. 4, it is assumed that subframe #n is subframe #8 and X is four. Furthermore, in FIG. 5, similar to FIG. 4, CSI-RS transmission is configured in subframes #4 and #9 by high layer signaling.

Referring to FIG. 5A, since subframe #n-4 (#4) is a partial subframe, it does not satisfy above condition 4, and CSI cannot be measured based on the CSI-RS in subframe #n-4 (#4). Consequently, by performing listening for DRS transmission just before subframe #n-4 (#4), it may be possible to measure CSI in subframe #n-4 (#4) based on the CSI-RS for CSI measurement arranged in the DRS transmission subframe.

However, since the DRS can be transmitted only in DMTC durations having a longer cycle than the CSI-RS transmission cycle, so that subframe #n-4 does not necessarily coincide with the DRS transmission subframe. Also, if an existing CSI reference resource (see condition 2 above) is used, when CSI-RS transmission of a predetermined cycle is configured in subframes other than subframes #0 and #5, the CRS scrambling sequence does not match the actual subframe index. Therefore, as shown in FIG. 5A, when the CSI-RS transmission subframe of a predetermined cycle is configured in subframes #4 and #9, even if this CSI-RS transmission subframe and the DRS transmission subframe match, the CRS scrambling sequence does not match actual subframe index #4, and therefore it is not possible to measure CSI based on the CSI-RS in subframe #n-4.

Therefore, in the second example, listening for CSI-RS transmission is performed shortly before subframe #n-4, so that the CSI-RS, not including the PDSCH, is transmitted in subframe #n-4 (subframe not coinciding with the DRS transmission subframe). To be more specific, the radio base station executes listening before transmitting the above CSI-RS by applying a sensing period that is shorter than a predetermined period of time. Meanwhile, the transmission period of the CSI-RS is set to one ms or less, thereby maintaining fairness with other systems (for example, Wi-Fi (registered trademark)).

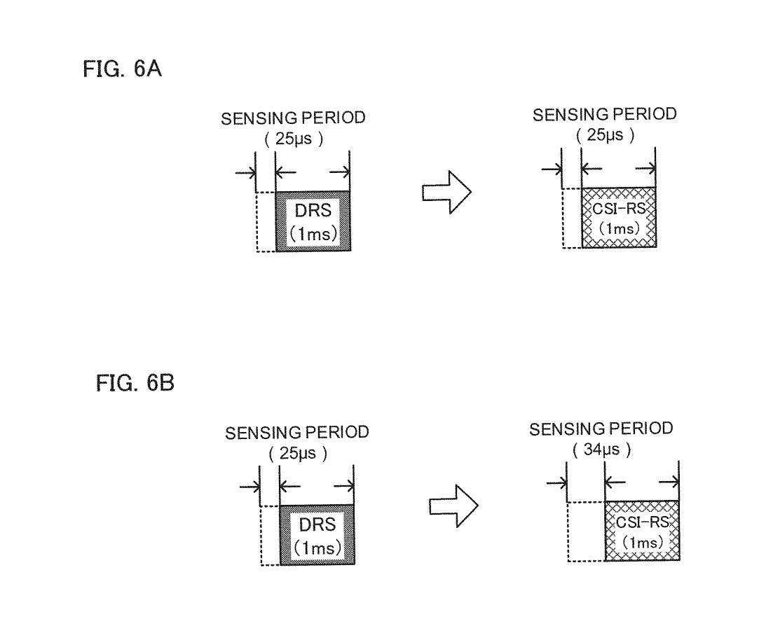

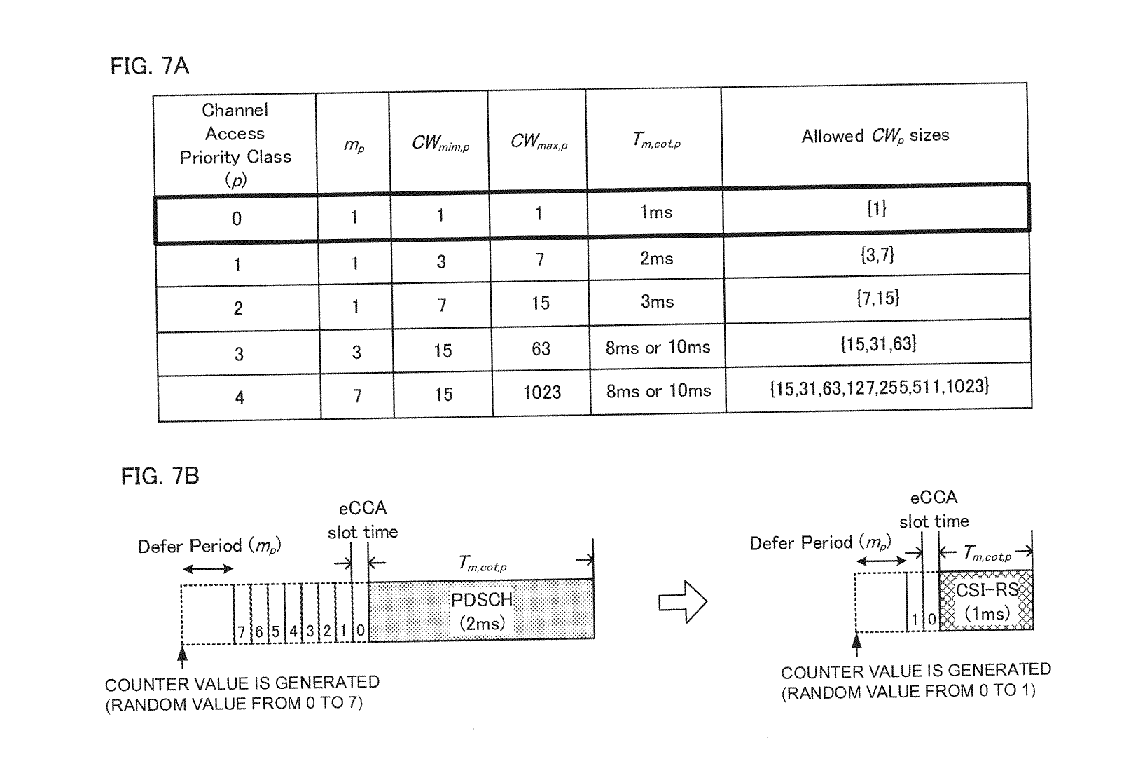

As shown in FIG. 5B, the radio base station performs listening (short LBT) shortly before subframe #n-4 (#4), and uses subframe #n-4 (#4) as a full subframe. The radio base station transmits the CSI-RS without including a PDSCH in this full subframe. Any of following rules 1 to 4 may be applied to this CSI-RS transmission not including the PDSCH. FIGS. 6 and 7 are diagrams to explain examples of rules applied to CSI-RS transmission not including the PDSCH.

<Rule 1>

As shown in FIG. 6A, in DRS transmission not including the PDSCH, if the channel is idle in the sensing period of 25 μs, transmission in a period of one ms or less is permitted. The rules applied to DRS transmission not including the PDSCH may be directly applied to CSI-RS transmission not including the PDSCH. That is, if the channel is in the idle state in the sensing period of 25 μs, the radio base station performs CSI-RS transmission not including the PDSCH in a period of one ms or less.

By configuring the sensing period to apply to CSI-RS transmission to the same period as in DRS transmission, interrupts from other systems can be easily avoided. Meanwhile, by limiting the transmission period to one ms or less, fairness with other systems can be maintained.

<Rule 2>

Alternatively, as shown in FIG. 61, a sensing period longer than the sensing period applied to DRS transmission not including the PDSCH may be applied to CSI-RS transmission not including the PDSCH. For example, when the channel is in the idle state in the sensing period of 34 μs, the radio base station performs CSI-RS transmission that does not include the PDSCH in a period of one ms or less.

By making the sensing period to apply to CSI-RS transmission longer than in DRS transmission, other systems (for example, Wi-Fi (registered trademark)) are more likely to interrupt than before CSI-RS transmission than before DRS transmission. For this reason, the priority of CSI-RS transmission is lower than the priority of DRS transmission. Note that the sensing period has only to be longer than 25 is, which is applied to DRS transmission, and is not limited to 34 μs.

<Rule 3>

Alternatively, as shown in FIG. 7A, a new class (Channel Access Priority Class) (for example, class 0) may be provided in a table that defines various parameters to use in listening before PDSCH transmission. Random backoff is applied to the listening before PDSCH transmission.

Random backoff refers to the mechanism, whereby, even when a channel enters the idle state, each transmission point does not start transmission soon, but defers transmission for a randomly-configured period and then starts transmission when the channel is clear. The window size in random backoff (also referred to as “contention window” (CW)) refers to the window size for determining the range of the backoff period, which is configured randomly.

The random backoff period can be determined based on counter values (random values), which are configured on a random basis. The range of counter values is determined based on the contention window (CW) size, and, for example, the counter values are configured on a random basis from the range from 0 to the CW size (integer value). CW_{min,p} and CW_{max,p} in FIG. 7A show the minimum value and the maximum value of the CW size, respectively. The CW size is selected from predetermined values (allowed CWₚ sizes) within the range from the minimum value to the maximum value.

As shown in FIG. 7B, a radio base station generates a counter value for random backoff when judging that a channel is in the idle state based on CCA. Then, the radio base station holds the counter value until it can be confirmed that the channel has been free for a predetermined defer period (a period that is determined based on mₚ in FIG. 7A). When it is confirmed that the channel has been idle for the predetermined period, the radio base station can then perform sensing in a predetermined time unit (for example an eCCA slot time unit), lower the counter value if the channel is idle, and make transmission when the counter value becomes zero.

When class 1 of FIG. 7A is applied to listening before PDSCH transmission, as shown in FIG. 7B, for example, the counter value is randomly configured from 0 to 7 (here, 7), and decremented from 7 to 0 after the predetermined defer period (here, a period determined based on mₚ=1). When the channel is free until the counter value becomes 0, the radio base station performs PDSCH transmission.

On the other hand, when class 0, newly defined as shown in FIG. 7A, is applied to listening before PDSCH transmission, then, as shown in FIG. 7B, for example, the counter value is randomly configured between 0 and 1 (here, configured to 1) and decremented from 1 to 0 after a predetermined defer period (in this case, a period determined based on mₚ=1). When the channel is free until the counter value becomes 0, the radio base station performs CSI-RS transmission.

In this manner, by performing listening before CSI-RS transmission using class 0 with a shorter back-off period, it becomes easier to avoid interruption from other systems (for example, Wi-Fi (registered trademark)). Various parameters specified in class 0 are not limited to those shown in FIG. 7A.

<Rule 4>

Alternatively, as described in rule 3, instead of providing new class 0, class 1 with the shortest back-off period among existing classes 1 to 4 may be applied to listening before CSI-RS transmission not including the PDSCH.

The above rules 1 to 4 are not limited to listening before CSI-RS transmission not including the PDSCH, and can be applied to transmission of one ms or less not including the PDSCH. For example, the above rules 1 to 4 may be applied to CRS transmission not including the PDSCH, PDCCH transmission for uplink grant, and so on.

As described above, in the second example, the radio base station can perform listening of a short sensing period and listening for one-ms or shorter transmission not including the PDSCH. In particular, in the second example, when the CSI-RS transmission subframe of a predetermined cycle is a partial subframe, the partial subframe can be changed to a full subframe by performing the above listening shortly in advance. As a result of this, the user terminal can measure CSI based on the CSI-RS in a subframe closer to the reporting timing.

### Third Example

In the third example, the measurement reference signal (CRS or CSI-RS) is transmitted in the partial subframe provided at the end of a transmission burst, so that it is possible to measure CSI using a CSI-RS in subframe that is as close to reporting timing as possible. Note that the third embodiment may be used alone or in combination with the first and/or the embodiment.

When CRS-based CSI measurement is made using existing CSI reference resources (the nearest subframe that satisfies condition 1 predetermined time X or more before CSI transmission subframe #n), if the last of the transmission burst is a partial subframe and the other subframes in the transmission burst are MBSFN subframes, subframes in which CSI can be measured are present only before the transmission burst.

Also, when CSI is measured based on the CSI-RS, the CSI-RS transmission cycle is 5 ms at the shortest. Therefore, if the transmission timing of the CSI-RS matches the last partial subframe of a transmission burst, whether an existing CSI reference resource (the nearest subframe which satisfies condition 2 predetermined time X or more before CSI transmission subframe #n) or an enhanced CSI reference resource (the nearest subframe satisfying condition 4 predetermined time X or more before CSI transmission subframe #n) is used, subframes in which CSI can be measured are present only 5 ms or more before.

Therefore, it is desirable to be able to transmit measurement reference signals (especially the CSI-RS) in partial subframes as well. Meanwhile, since existing user terminals perform the receiving process (for example, rate matching) of the PDSCH and the enhanced downlink control channel (EPDCCH: Enhanced Physical Downlink Control Channel) on the assumption that the CSI-RS is not transmitted in partial subframes, when a CSI-RS is newly transmitted in a partial subframe, the user terminal may not be able to demodulate the PDSCH or the EPDCCH appropriately.

Therefore, in the third example, the measurement reference signal (the CRS or the CSI-RS) is transmitted in additional symbols that are added after the partial subframe provided at the end of a transmission burst. In these additional symbols, only the measurement reference signal (CRS or CSI-RS) may be transmitted. By providing additional symbols for a measurement reference signal after a partial subframe, a measurement reference a signal can be transmitted in the partial subframe while maintaining backward compatibility with existing user terminals that do not assume the presence of the CSI-RS.

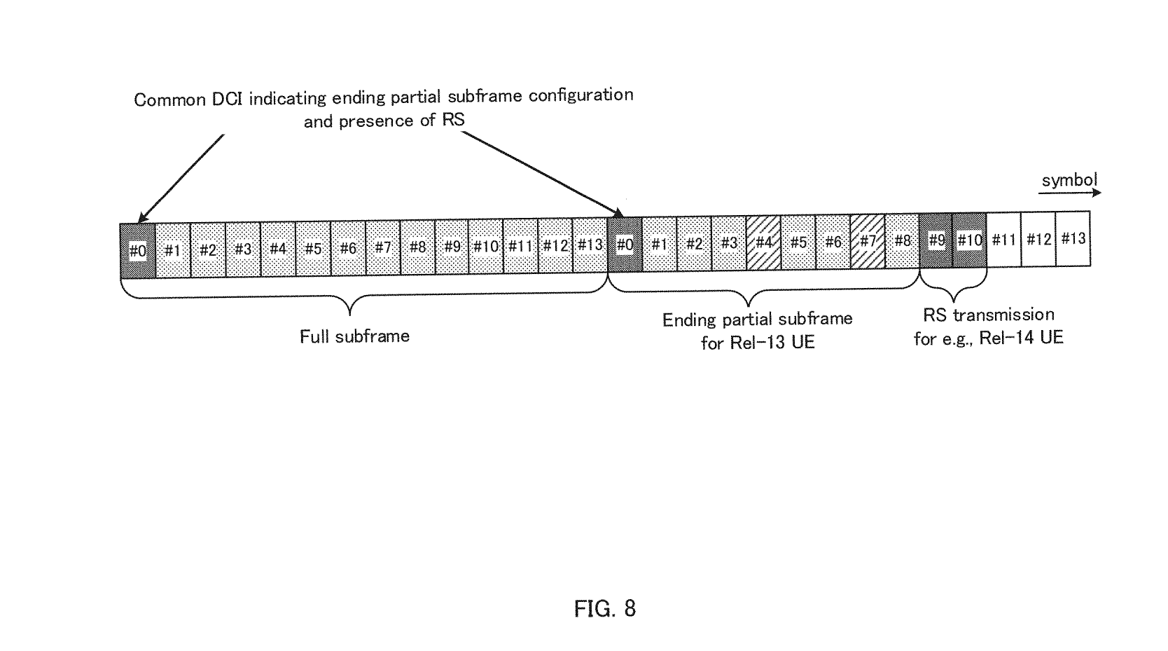

FIG. 8 is a diagram to show an example of a transmission burst according to the third example.

In FIG. 8, a partial subframe (ending partial subframe) comprised of symbols #0 to #8 is provided at the end of a transmission burst. This partial subframe is recognized by existing user terminals (for example, Rel. 13 UE). In this partial subframe, for example, the CRSs of port 0/1 are placed in symbols #0, #4 and #7. On the other hand, no CSI-RS is arranged in this partial subframe.

As shown in FIG. 8, in additional symbols #9 and #10 after the partial frame, the CRS or the CSI-RS is arranged for user terminals that are allowed to measure CSI in partial subframes (for example, Rel. 13 option UEs or a Rel. 14 UEs). Within additional symbols, only the CRS or the CSI-RS may be transmitted.

Also, in FIG. 8, when the time duration of the transmission burst including the additional symbols exceeds the maximum value (for example, 4 ms), it may be possible to adjust the configuration of the partial subframe (for example, reduce the number of symbols) and then provide additional symbols.

Also, in FIG. 8, information to indicate the presence or absence of additional symbols for the measurement reference signal in the partial subframe may be included in the common control information (common DCI) that is transmitted in the partial subframe and the immediately-preceding full subframe. Furthermore, the common control information may include information indicating the configuration of the partial subframes (for example, the number of symbols). By reporting the number of symbols in the partial subframe, the user terminal can properly perform the receiving process (rate matching) of the PDSCH/EPDCCH by identifying the CRS in the partial subframe. Note that, in FIG. 8, the common control information is arranged only in symbol #0, but this is by no means limiting.

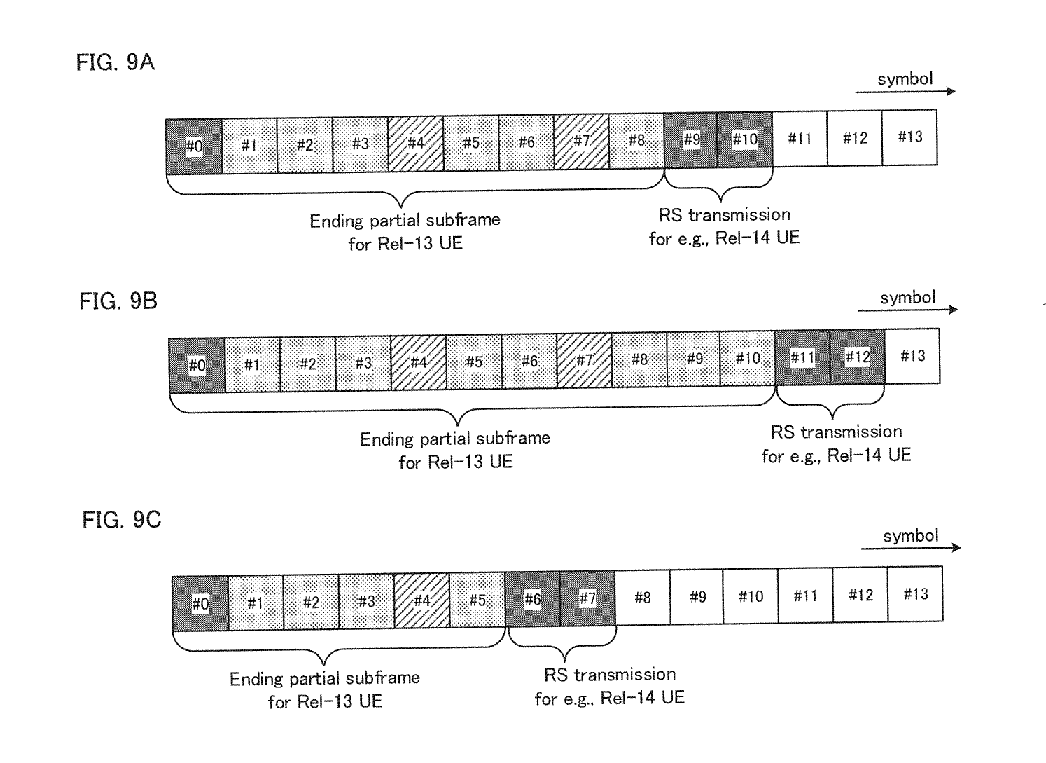

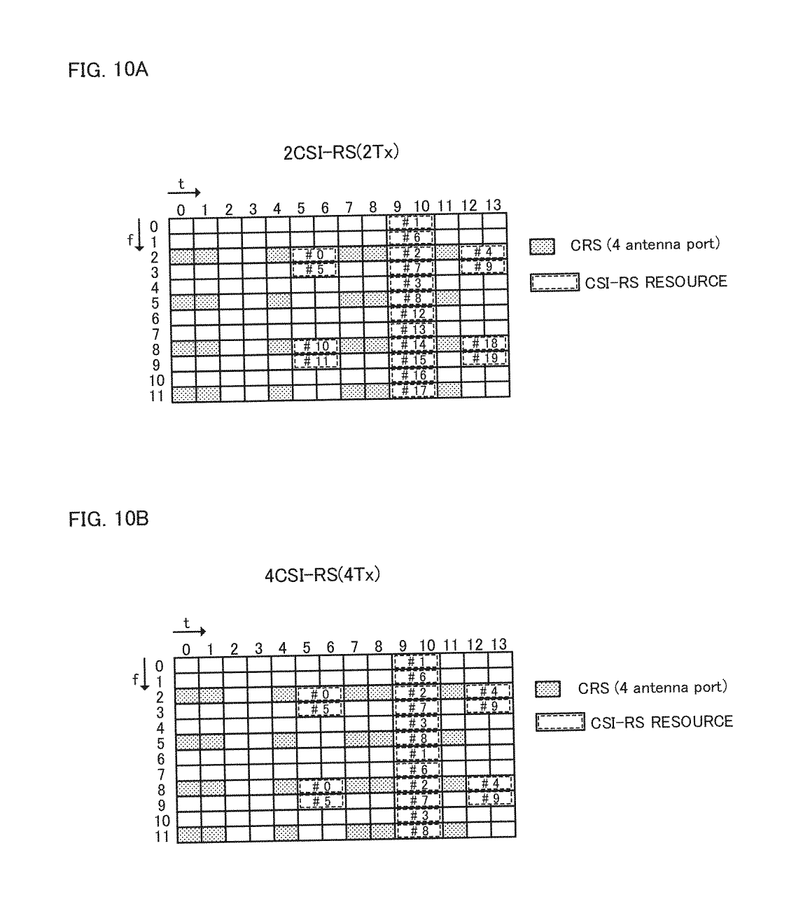

FIG. 9 provide diagrams to show examples of configurations of additional symbols including the CSI-RS according to the third example. In a full subframe, as shown in FIG. 10, predetermined resource elements (REs) of symbols #5, #6, #9, #10, #11 and #13 are reserved (for example, CSI-RS resources #0 to #19 are reserved when two antenna ports are used and CSI-RS resources #0 to #9 are reserved when four antenna ports are used), and one CSI-RS resources is configured in each user terminal. Additional symbols including the CSI-RS may be configured based on the symbol location of the CSI-RS configured in the user terminal or may be configured irrespective of the symbol location.

In the example shown in FIG. 9A, additional symbols are configured based on the symbol location of the CSI-RS in the full subframe. In FIG. 9A, the CSI-RS resources of the user terminal are configured in symbols #9 and #10 in the full subframe. In this case, as shown in FIG. 9A, additional symbols including the CSI-RS may be provided only in a partial subframe comprised of symbols #0 to #8. Alternatively, the number of symbols in the partial subframe may be adjusted so that additional symbols can be placed in symbols #9 and #10.

In the examples shown in FIGS. 9B and 9C, the additional symbols are configured irrespective of the symbol location of the CSI-RS in the full subframe. In FIG. 9B, even when CSI-RS resources of the user terminal are configured in symbols #9 and #10, additional symbols #11 and #12 including the CSI-RS are placed after the partial subframe comprised of symbols #0 to #10. Similarly, in FIG. 9C, additional symbols #6 and #7 including the CSI-RS are placed after the partial subframe comprised of symbols #0 to #5.

Given that the CRS is transmitted in partial subframes, the location of additional symbols including the CRS does not have to take into consideration the CSI-RS location in the full subframe, unlike the case with the CSI-RS that is not transmitted in a partial subframe.

Also, in the third example, when CRS-based CSI measurement is made using an enhanced CSI reference resource, the accuracy of CRS-based CSI measurement in partial subframes can be improved. Note that, the CSI measurement using partial subframes according to the third example may be performed in resources other than the enhanced CSI reference resource described in the first example.

For example, in the context of the first example, the user terminal may perform CSI-RS-based CSI measurement in the nearest subframe satisfying condition 5 predetermined time X or more before CSI transmission subframe #n.

<Condition 5>
There is downlink transmission in the serving cell; and
CSI-RS transmission of a predetermined cycle is configured.

According to condition 5, unlike condition 4 above, CSI-RS-based CSI measurement in is permitted partial subframes, so that it becomes possible to measure CSI based on the CSI-RS in a subframe closer to the reporting timing.

(Radio Communication System)

Now, the structure of the radio communication system according to the present embodiment will be described below. In this radio communication system, the radio communication methods according to each of the above-described examples are employed. Note that the radio communication methods according to each example may be used alone or in combination.

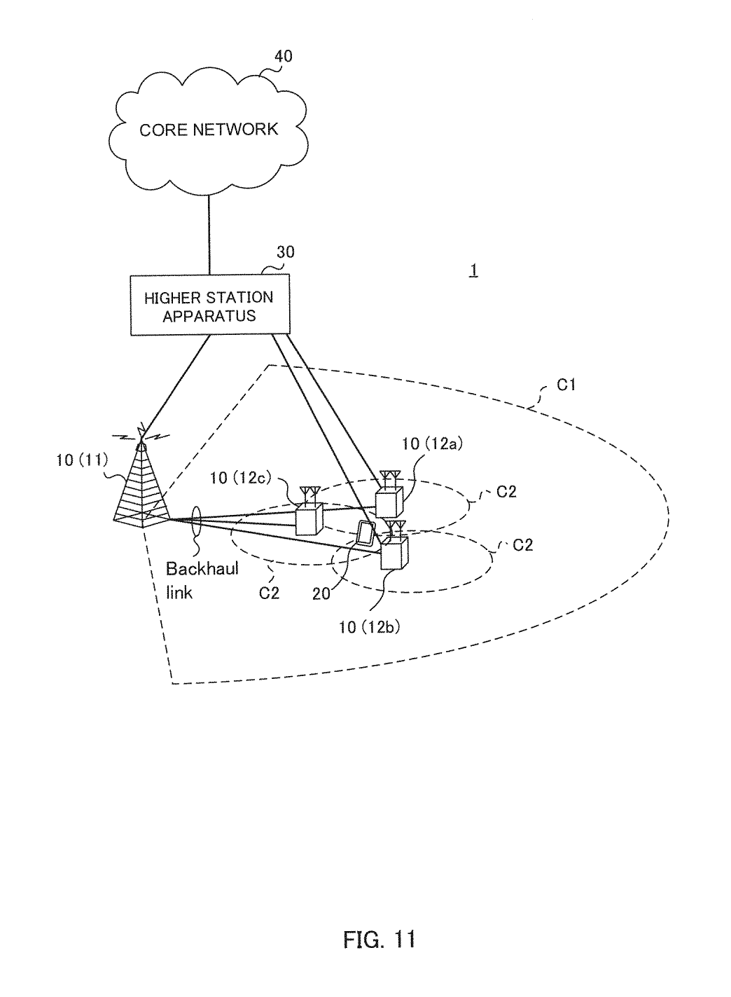

FIG. 11 is a diagram to show an example of a schematic structure of a radio communication system according to the present embodiment. The radio communication system 1 can adopt carrier aggregation (CA) and/or dual connectivity (DC) to group a plurality of fundamental frequency blocks (component carriers) into one, where the LTE system bandwidth constitutes one unit. Also, the radio communication system 1 has a radio base station (for example, an LTE-U base station) that is capable of using unlicensed bands.

Note that the radio communication system 1 may be referred to as “SUPER 3G,” “LTE-A.” (LTE-Advanced).” “IMT-Advanced,” “4G” (4th generation mobile communication system), “5G” (5th generation mobile communication system), “FRA” (Future Radio Access) and so on.

The radio communication system 1 shown in FIG. 11 includes a radio base station 11 that forms a macro cell C1, and radio base stations 12 (12a to 12c) that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and the small cells C2 are used in unlicensed bands (LTE-U). Also, a mode may be also possible in which part of the small cells is used in a licensed band and the rest of the small cells are used in unlicensed bands.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the DL signal configuration) related to a radio base station 12 (which is, for example, an LTE-U base station) that uses an unlicensed band, from the radio base station 11 that uses a licensed band to the user terminals 20. Here, a structure may be employed in which, when CA is used between the licensed band and the unlicensed band, one of the radio base stations (for example, the radio base station 11) controls the scheduling of the licensed band cells and the unlicensed band cells.

Note that it is equally possible to use a structure in which a user terminal connects with a radio base station 12, without connecting with the radio base station 11. For example, it is possible to use a structure in which a radio base station 12 that uses an unlicensed band connects with the user terminals 20 in stand-alone. In this case, the radio base station 12 controls the scheduling of unlicensed band cells.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the configuration of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with higher station apparatus 30 via the radio base station 11.

Note that the radio base station 11 is a radio base station having a relatively wide coverage, and may be referred to as a “macro base station,” a “central node.” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as “radio base stations 10,” unless specified otherwise. Also, it is preferable to configure radio base stations that use the same unlicensed band on a shared basis to be synchronized in time.

The user terminals 20 are terminals to support various communication schemes such as LTE, LTE-A and so on, and may be either mobile communication terminals or stationary communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. The PDSCH may be referred to as a “down link data channel.” User data, higher layer control information and predetermined SIBs (System Information Blocks) are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. A CFI (Control Format Indicator), which indicates the number of OFDM symbols to use for the PDCCH, is communicated by the PCFICH. HARQ delivery acknowledgement signals (ACKs/NACKs) in response to the PUSCH are communicated by the PHICH. The EPDCCH is frequency-division-multiplexed with the PDSCH and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. The PUSCH may be referred to as an uplink data channel. User data and higher layer control information are communicated by the PUSCH. Also, downlink radio quality information (CQI: Channel Quality Indicator), delivery acknowledgment information (ACKs/NACKs) and so on are communicated by the PUCCH. By means of the PRACH, random access preambles for establishing connections with cells are communicated.

In the radio communication systems 1, cell-specific reference signals (CRSs), channel state information reference signals (CSI-RSs), demodulation reference signal (DMRSs), detection/measurement reference signals (DRSs (Discovery Reference Signals) and so on are communicated as downlink reference signals. Also, in the radio communication system 1, the measurement reference signal (SRS: Sounding Reference Signal), the demodulation reference signal (DMRS) and so on are communicated as uplink reference signals. Note that, DMRSs may be referred to as “user terminal-specific reference signals” (UE-specific Reference Signals). Also, the reference signals to be communicated are by no means limited to these.

<Radio Base Station>

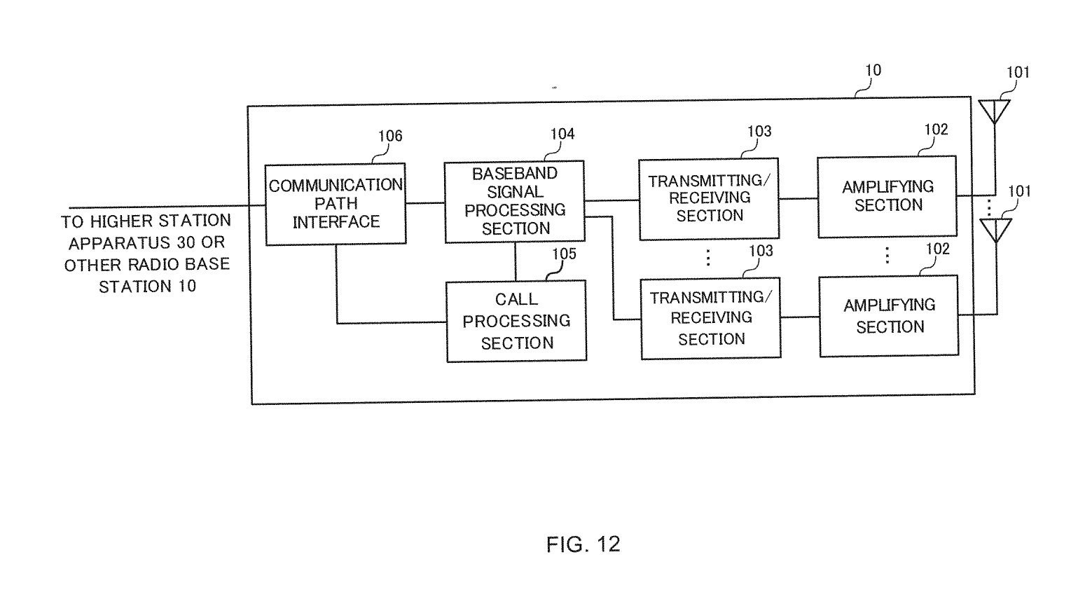

FIG. 12 is a diagram to show an example of an overall structure of a radio base station according to the present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving sections 103. Furthermore, downlink control signals are also subjected to transmission processes such as channel coding and an inverse fast Fourier transform, and forwarded to each transmitting/receiving sections 103.

Baseband signals that are pre-coded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101.

The transmitting/receiving sections 103 are capable of transmitting/receiving uplink (UL)/downlink (DL) signals in unlicensed bands. Note that the transmitting/receiving sections 103 may be capable of transmitting/receiving UL/DL signals in licensed bands as well. The transmitting/receiving sections 103 can be constituted by transmitters/receivers, transmitting/receiving circuits or transmitting/receiving devices that can be described based on common understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (for example, an interface in compliance with the CPRI (Common Public Radio Interface) m such as optical fiber, the X2 interface).

Note that the transmitting/receiving sections 103 transmit downlink signals to the user terminal 20 by using at least an unlicensed band. For example, the transmitting/receiving sections 103 transmit a measurement reference signal (CRS or CSI-RS) in an unlicensed band. As mentioned above, the DRS includes at least one of the CRS, the PSS/SSS and the CSI-RS for RRM measurement. Also, when the transmission timing of the CSI-RS configured in a predetermined cycle matches the transmission timing of the DRS in the DMTC duration that is configured in the DMRS cycle, the DRS transmission subframe may include the CSI-RS for CSI measurement. That is, the measurement reference signal may be a CRS included in the DRS or a CSI measurement CSI-RS arranged in the DRS transmission subframe.

Also, the transmitting/receiving sections 103 receive uplink signals from the user terminal 20 by using at least an unlicensed band. For example, the transmitting/receiving sections 103 may transmit RRM measurement and/or CSI measurement results (for example, CSI feedback) in a licensed band and/or an unlicensed band.

In addition, the transmitting/receiving sections 103 may receive, from the user terminal 20, capability information that indicates whether or not the user terminal 20 can measure CSI in an enhanced CSI reference resource (for example, the nearest subframe that satisfies condition 3 or 4 predetermined time X or more before CSI transmission subframe #n). The capability information may be received via higher layer signaling such as RRC signaling (first example).

Alternatively, the transmitting/receiving section 103 may transmit, to the user terminal 20, command information to command whether or not to measure CSI in an enhanced CSI reference resource (for example, the nearest subframe satisfying condition 3 or 4 predetermined time X or more before CSI transmission subframe #n). This command information may be transmitted via higher layer signaling such as RRC signaling (first example).

Further, in a partial subframe at the end of a transmission burst and in the immediately-preceding full subframe, the transmitting/receiving sections 103 may transmit information on transmission of the measurement reference signal in additional symbols (for example, information to indicate the configuration of the partial subframe and/or the presence or absence of additional symbols). This information may be included in common control information (common DCI) that is transmitted using a physical control channel such as the PDCCH, or may be included in unique control information (UE-specific DCI).

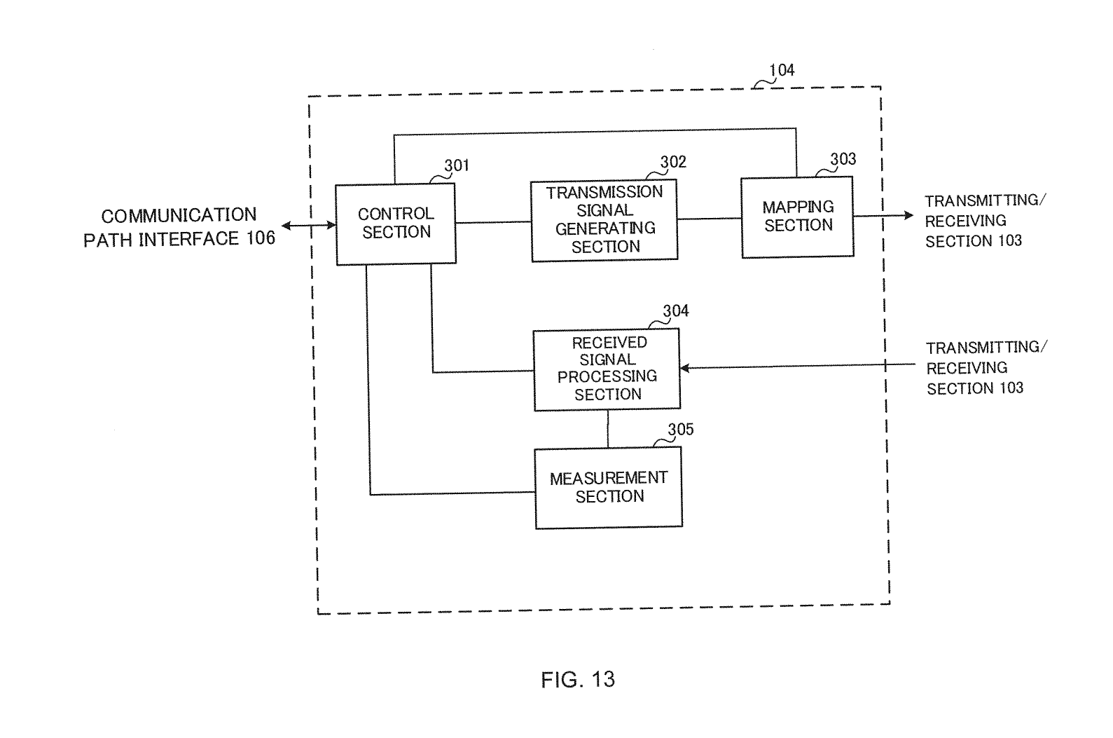

FIG. 13 is a diagram to show an example of a functional structure of a radio base station according to one embodiment of the present invention. Note that, although FIG. 13 primarily shows functional blocks that pertain to characteristic parts of the present embodiment, the radio base station 10 has other functional blocks that are necessary for radio communication as well. As shown in FIG. 13, the baseband signal processing section 104 has a control section (scheduler) 301, a transmission signal generation section 302, a mapping section 303, a received signal processing section 304 and a measurement section 305.

The control section (scheduler) 301 controls the whole of the radio base station 10. Note that, when a licensed band and an unlicensed band are scheduled with one control section (scheduler) 301, the control section 301 controls communication in the licensed band cells and the unlicensed band cells. For the control section 301, a controller, a control circuit or a control device that can be described based on common understanding of the technical field to which the present invention pertains can be used.

The control section 301, for example, controls the generation of signals in the transmission signal generation section 302, the allocation of signals by the mapping section 303, and so on. Furthermore, the control section 301 controls the signal receiving processes in the received signal processing section 304, the measurements of signals in the measurement section 305, and so on.

The control section 301 controls the scheduling of system information, downlink data signals that are transmitted in the PDSCH and downlink control signals (common control information and dedicated control information) that are communicated in the PDCCH and/or the EPDCCH. Also, the control section 301 controls the scheduling, generation, mapping and transmission of synchronization signals (PSS (Primary Synchronization Signal) and/or SSS (Secondary Synchronization Signal)) and downlink reference signals such as the CRS, the CSI-RS, the DMRS and the DRS.

Also, the control section 301 controls the scheduling, reception, etc. of uplink data signals transmitted in the PUSCH, uplink control signals transmitted in the PUCCH and/or the PUSCH (for example, delivery acknowledgement signals (HARQ-ACKs)), random access preambles transmitted in the PRACH, uplink reference signals and so on.

To be more specific, the control section 301 controls communication based on CSI that is measured using existing CSI reference resources or enhanced CSI reference resources. Here, enhanced CSI reference resources may be defined so that CSI can be measured in at least one of an MBSFN subframe, a partial subframe and a DRS (detection signal) transmission subframe, other than subframe index #0 or #5, which coincides with a CSI-RS transmission subframe (first example).

Further, the control section 301 controls LBT (listening) by the measuring section 305, and controls the transmission signal generation section 302 and the mapping section 303 to transmit downlink signals according to LBT results.

To be more specific, the control section 301 controls the measurement section 305 to perform LBT according to rules 1 to 4 before one-ms or shorter downlink transmission (for example, CSI-RS transmission) not including the PDSCH (second example). Note that the control section 301 may control the measurement section 305 to perform LBT based on parameters defined according to one of classes 1 to 4 shown in FIG. 7A, before downlink transmission including the PDSCH. Further, the control section 301 may control the measurement section 305 to perform LBT in a sensing period of 25 μs before DRS transmission not including the PDSCH.

Further, the control section 301 may control the transmission signal generation section 302, the mapping section 303, and the transmitting/receiving section 103 so that the measurement reference signal is transmitted in additional symbols added after the partial subframe provided at the end of a transmission burst (third example).

The transmission signal generation section 302 generates downlink signals (downlink control signals, downlink data signals, downlink reference signals and so on) based on commands from the control section 301, and outputs these signals to the mapping section 303. The transmission signal generation section 302 can be constituted by a signal generator, a signal generating circuit or a signal generating device that can be described based on common understanding of the technical field to which the present invention pertains.

For example, the transmission signal generation section 302 generates DL assignments, which report downlink signal allocation information, and UL grants, which report uplink signal allocation information, based on commands from the control section 301. Also, the downlink data signals are subjected to a coding process and a modulation process by using coding rates, modulation schemes and so on, determined based on the results of CSI measurement in each user terminal and so on. Also, the transmission signal generation section 302 generates a DRS that includes a PSS, an SSS, a CRS, a CSI-RS and so on. Also, the transmission signal generation section 302 generates common control information and unique control information based on commands from the control section 301 (including the coding process, the modulation process, and so on).

The mapping section 303 maps the downlink signals generated in the transmission signal generation section 302 to predetermined radio resources based on commands from the control section 301, and outputs these to the transmitting/receiving sections 103.

To be more specific, based on a command from the control section 301, the mapping section 303 may map the CRS or the CSI-RS in additional symbols provided after a partial subframe. The mapping section 303 can be constituted by a mapper, a mapping circuit or a mapping device that can be described based on common understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminals 20 (uplink control signals, uplink data signals, uplink reference signals and so on). For the received signal processing section 304, a signal processor, a signal processing circuit or a signal processing device that can be described based on common understanding of the technical field to which the present invention pertains can be used.

The received signal processing section 304 outputs the decoded information acquired through the receiving processes to the control section 301. For example, when a PUCCH to contain an HARQ-ACK is received, the received signal processing section 304 outputs this HARQ-ACK to the control section 301. Also, the received signal processing section 304 outputs the received signals, the signals after the receiving processes and so on, to the measurement section 305.

The measurement section 305 conducts measurements with respect to the received signals. The measurement section 305 can be constituted by a measurer, a measurement circuit or a measurement device that can be described based on common understanding of the technical field to which the present invention pertains.

The measurement section 305 executes LBT in a carrier where LBT is configured (for example, an unlicensed band) based on commands from the control section 301, and outputs the results of LBT (for example, judgments as to whether the channel state is idle or busy) to the control section 301.

Also, the measurement section 305 may measure the received power (for example, the RSRP (Reference Signal Received Power)), the received quality (RSRQ (Reference Signal Received Quality)), the channel states and so on of the received signals. The measurement results may be output to the control section 301.

<User Terminal>

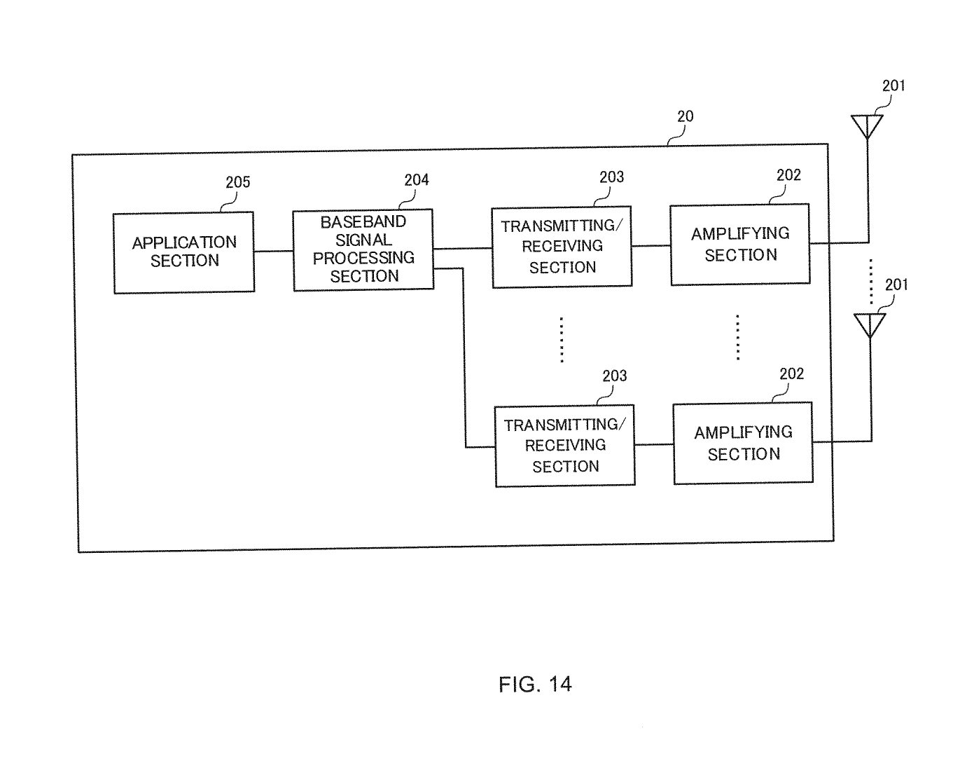

FIG. 14 is a diagram to show an example of an overall structure of a user terminal according to the present embodiment. A user terminal 20 has a plurality of transmitting/receiving antennas 201, amplifying sections 202, transmitting/receiving sections 203, a baseband signal processing section 204 and an application section 205. Note that one or more transmitting/receiving antennas 201, amplifying sections 202 and transmitting/receiving sections 203 may be provided.

A radio frequency signal that is received in the transmitting/receiving antenna 201 is amplified in the amplifying section 202. The transmitting/receiving section 203 receives the downlink signal amplified in the amplifying section 202. The received signal is subjected to frequency conversion and converted into the baseband signal in the transmitting/receiving sections 203, and output to the baseband signal processing section 204. The transmitting/receiving sections 203 are capable of transmitting/receiving UL/DL signals in unlicensed bands. Note that the transmitting/receiving sections 203 may be capable of transmitting/receiving UL/DL signals in licensed bands as well.

The transmitting/receiving section 203 can be constituted by a transmitters/receiver, a transmitting/receiving circuit or a transmitting/receiving device that can be described based on common understanding of the technical field to which the present invention pertains. Note that the transmitting/receiving section 203 may be structured as a transmitting/receiving section in one entity, or may be constituted by a transmitting section and a receiving section.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to the transmitting/receiving section 203. The baseband signal that is output from the baseband signal processing section 204 is converted into a radio frequency bandwidth in the transmitting/receiving sections 203. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 receive downlink signals transmitted from the radio base station 10, by using at least an unlicensed band. For example, the transmitting/receiving section 203 receives the above-noted measurement reference signal in an unlicensed band.

Also, the transmitting/receiving sections 203 transmit uplink signals to the radio base station 10 by using at least an unlicensed band. For example, the transmitting/receiving sections 203 may transmit DRS RRM measurement results and/or CSI measurement results (for example, CSI feedback) in a licensed band and/or an unlicensed band. In addition, CSI may be transmitted using the PUCCH, or may be transmitted using the PUSCH.

Further, the transmitting/receiving section 203 may transmit, to the radio base station 10, capability information that indicates whether or not the user terminal 20 can measure CSI in an enhanced CSI reference resource (for example, the nearest subframe satisfying condition 3 or 4 predetermined time X or more before CSI transmission subframe #n). The capability information may be received by higher layer signaling such as RRC signaling (first example).

Alternatively, the transmitting/receiving section 203 may receive, from the radio base station 10, command information that commands whether or not to measure CSI n an enhanced CSI reference resource (for example, the nearest subframe satisfying condition 3 or 4 predetermined time X or more before CSI transmission subframe #n). The command information may be transmitted via higher layer signaling such as RRC signaling (first example).

Further, in a partial subframe at the end of a transmission burst and in the immediately-preceding full subframe, the transmitting/receiving section 203 may transmit information on transmission of the measurement reference signal in additional symbols (for example, information to indicate the configuration of the partial subframe and/or the presence or absence of additional symbols). This information may be included in common control information (common DCI) that is transmitted using a physical control channel such as the PDCCH, or may be included in unique control information (UE-specific DCI).

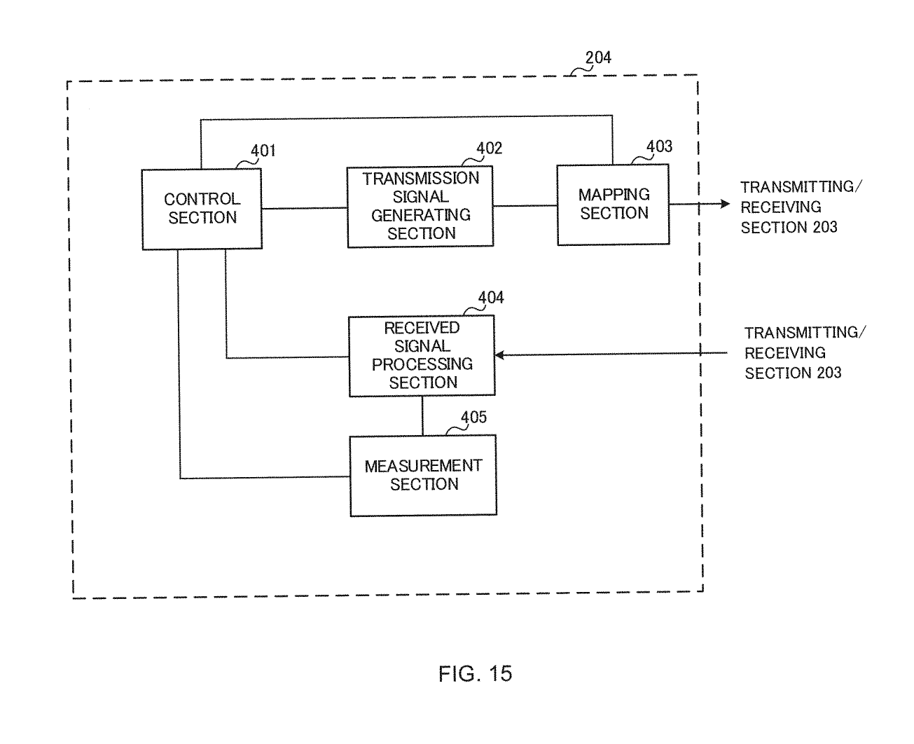

FIG. 15 is a diagram to show an example of a functional structure of a user terminal according to one embodiment of the present invention. Note that, although FIG. 15 primarily shows functional blocks that pertain to characteristic parts of the present embodiment, the user terminal 20 has other functional blocks that are necessary for radio communication as well. As shown in FIG. 15, the baseband signal processing section 204 provided in the user terminal 20 at least has a control section 401, a transmission signal generation section 402, a mapping section 403, a received signal processing section 404 and a measurement section 405.

The control section 401 controls the whole of the user terminal 20. For the control section 401, a controller, a control circuit or a control device that can be described based on common understanding of the technical field to which the present invention pertains can be used.

The control section 401, for example, controls the generation of signals in the transmission signal generation section 402, the allocation of signals by the mapping section 403, and so on. Furthermore, the control section 401 controls the signal receiving processes in the received signal processing section 404, the measurements of signals in the measurement section 405, and so on.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not re transmission control is necessary for the downlink data signals, and so on.

The control section 401 controls the received signal processing section 404 and the measurement section 405 to carry out RRM measurements and/or CSI measurements using measurement reference signals in an unlicensed band. Note that RRM measurement may be performed by using the DRS. Further, the measurement reference signal may be either the CRS, the CSI-RS, the CSI or the CSI-RS included in the DRS, etc.

Further, the control section 401 may determine the measurement subframe to use for CSI measurement in the measurement section 405. To be more specific, the control section 401 may determine the measurement subframe based on an enhanced CSI resource defined so that CSI can be measured in at least one of an MBSFN subframe, a partial subframe and a subframe of the DRS (detection signal), other than subframe index #0 or #5, that coincides with a CSI-RS transmission subframe (the first example).

For example, when measuring CSI based on the CRS, the control section 401 may determine the nearest subframe that, predetermined time X or more before the CSI transmission subframe, satisfies condition 3 that there is downlink transmission in the serving cell (unlicensed band cell) and the CRS scrambling sequence follows the actual subframe index (first example), as the measurement subframe.

Further, when measuring CSI based on the CS-RS, the control section 401 may determine the nearest subframe that, predetermined time X or more before the transmission subframe of CSI, satisfies condition 4 that there is downlink transmission in the serving cell (unlicensed band cell), transmission of the CSI-RS is configured and the subframe is not a partial subframe (first example), as the measurement subframe.

When the user terminal 20 cannot measure CSI in enhanced CSI reference resources (for example, Rel. 13 UE), the control section 401 may determine the measurement subframe based on existing CSI reference resources (the nearest subframe that satisfies condition 1 or 2 predetermined time X or more before CSI transmission subframe #n). Alternatively, the control section 401 may change whether the CSI is based on an enhanced CSI reference resource or an existing CSI reference resource, based on command information from the radio base station 10.

Further, the control section 401 may control the CSI measurement in the measurement section 405, the receiving process of the PDSCH/EPDCCH (for example, rate matching) in the received signal processing section 404 and so on based on information related to the transmission of the measurement reference signal in additional symbols (for example, information on the configuration of a partial subframe and/or information indicating the presence or absence of additional symbols), (third example).

Furthermore, the control section 401 may control the transmission signal generation section 402 and the mapping section 403 to transmit uplink signals based on LBT results acquired in the measurement section 405.

Also, based on common control information and/or unique control information, the control section 401 may control at least one of the channel state information (CSI) measurement, the synchronization, the PDSCH demodulation and the rate matching in the subframe in which the common control information and/or the unique control information are received. For example, the control section 401 may control at least one of CRS-based CSI measurement, PDSCH demodulation, and rate matching based on information indicating whether or not the subframe is an MBSFN subframe.

Also, the control section 401 may identify the signal configuration in the last subframe of a burst and, based on the result of this identification, control at least one of the RRM measurement, the CSI measurement and the PDSCH rate matching in the last subframe of the burst.

The transmission signal generation section 402 generates uplink signals (uplink control signals, uplink data signals, uplink reference signals and so on) based on commands from the control section 401, and outputs these signals to the mapping section 403. The transmission signal generation section 402 can be constituted by a signal generator, a signal generating circuit or a signal generating device that can be described based on common understanding of the technical field to which the present invention pertains.

Also, the transmission signal generation section 402 generates uplink data signals based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and output the result to the transmitting/receiving sections 203. The mapping section 403 can be constituted by a mapper, a mapping circuit or a mapping device that can be described based on common understanding of the technical field to which the present invention pertains.

The received signal processing section 404 performs receiving processes (for example, demapping, demodulation, decoding and so on) of received signals that are input from the transmitting/receiving section 203. Here, the received signals include, for example, downlink signals (downlink control signals, downlink data signals, downlink reference signals and so on) that are transmitted from the radio base station 10. The received signal processing section 404 can be constituted by a signal processor, a signal processing circuit or a signal processing device that can be described based on common understanding of the technical field to which the present invention pertains. Also, the received signal processing section 404 can constitute the receiving section according to the present invention.

The received signal processing section 404 output the decoded information that is acquired through the receiving processes to the control section 401. The received signal processing section 404 outputs, for example, broadcast information, system information, RRC signaling, DCI and so on, to the control section 401. Also, the received signal processing section 404 outputs the received signals, the signals after the receiving processes and so on to the measurement section 405.

The measurement section 405 conducts measurements with respect to the received signals. The measurement section 405 can be constituted by a measurer, a measurement circuit or a measurement device that can be described based on common understanding of the technical field to which the present invention pertains.

The measurement section 405 may execute LBT in a carrier where LBT is configured (for example, an unlicensed band) based on commands from the control section 401. The measurement section 405 may output the results of LBT (for example, judgments as to whether the channel state is idle or busy) to the control section 401.

Also, the measurement section 405 measures RRM and CSI according to commands from the control section 401. For example, the measurement section 405 measures CSI using the measurement reference signal (the CRS, the CSI-RS, the CRS included in the DRS or the CSI-RS for CSI measurement arranged in the DRS transmission subframe). The measurement result is output to the control section 401 and transmitted from the transmitting/receiving section 103 using the PUSCH or the PUCCH.

<Hardware Structure>

Note that the block diagrams that have been used to describe the above embodiments show blocks in functional units. These functional blocks (components) may be implemented in arbitrary combinations of hardware and/or software. Also, the means for implementing each functional block is not particularly limited. That is, each functional block may be implemented with one physically-integrated device, or may be implemented by connecting two physically-separate devices via radio or wire and using these multiple devices.

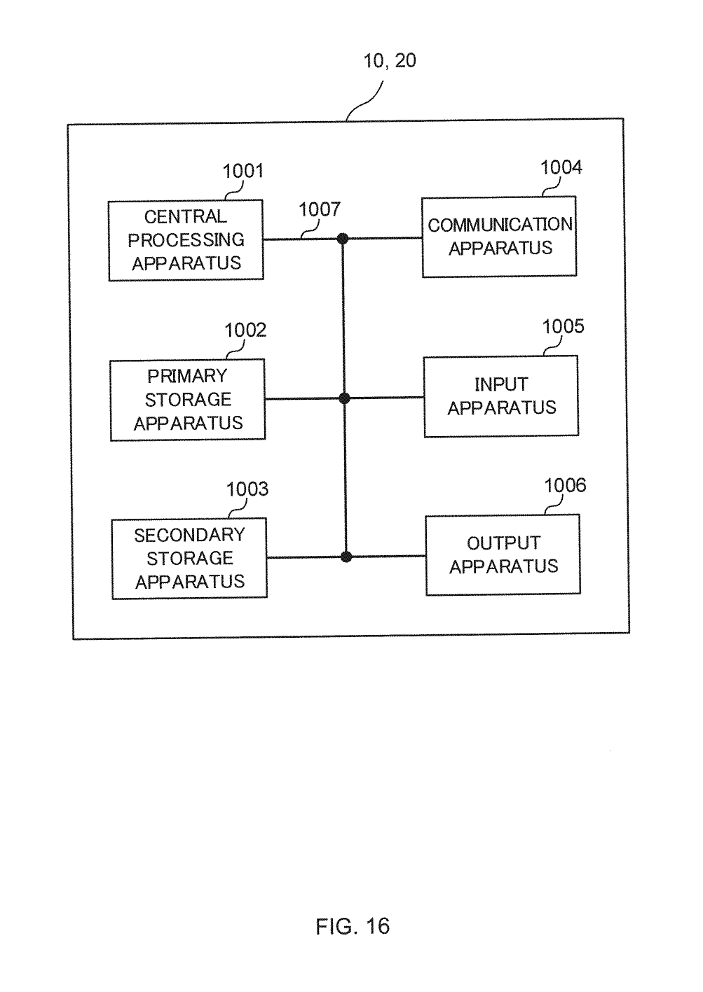

That is, a radio base station, a user terminal and so on according to an embodiment of the present invention may function as a computer that executes the processes of the radio communication method of the present invention. FIG. 16 is a diagram to show an example hardware structure of a radio base station and a user terminal according to an embodiment of the present invention. Physically, a radio base station 10 and a user terminal 20, which have been described above, may be formed as a computer apparatus that includes a central processing apparatus (processor) 1001, a primary storage apparatus (memory) 1002, a secondary storage apparatus 1003, a communication apparatus 1004, an input apparatus 1005, an output apparatus 1006 and a bus 1007.

Note that, in the following description, the word “apparatus” may be replaced by “circuit,” “device,” “unit” and so on. Note that the hardware structure of the radio base station 10 and the user terminal 20 may be designed to include one or more of each apparatus shown in the drawings, or may be designed not to include part of the apparatuses.

Each function of the radio base station 10 and user terminal 20 is implemented by reading predetermined software (programs) on hardware such as the central processing apparatus 1001, the primary storage apparatus 1002 and so on, and controlling the calculations in the central processing apparatus 1001, the communication in the communication apparatus 1004, and the reading and/or writing of data in the primary storage apparatus 1002 and the secondary storage apparatus 1003.

The central processing apparatus 1001 may control the whole computer by, for example, running an operating system. The processor 1001 may be configured with a central processing unit (CPU: Central Processing Unit) including an interface with a peripheral device, a control device, a computing device, a register, and the like. For example, the above-described baseband signal process section 104 (204), call processing section 105 and so on may be implemented by the central processing apparatus 1001.

Further, the processor 1001 reads a program (program code), a software module or data from the storage 1003 and/or the communication device 1004 to the memory 1002, and executes various processes according to these. As for the programs, programs to allow the computer to execute at least part of the operations of the above-described embodiments may be used. For example, the control section 401 of the user terminals 20 may be stored in memory 1002 and implemented by a control program that operates on processor 1001, and other functional blocks may be implemented likewise.

The primary storage apparatus (memory) 1002 is a computer-readable recording medium, and may be constituted by, for example, at least one of a ROM (Read Only Memory), an EPROM (Erasable Programmable ROM), a RAM (Random Access Memory) and so on. The memory 1002 may be referred to as a register, a cache, a main memory (main memory), or the like. The memory 1002 can store executable programs (program codes), software modules, and the like for implementing the wireless communication method according to one embodiment of the present invention.

The storage 1003 is a computer readable recording medium, and is configured with at least one of an optical disk such as a CD-ROM (Compact Disc ROM), a hard disk drive, a flexible disk, a magneto-optical disk, a flash memory and so on. The storage 1003 may be referred to as an auxiliary storage device.

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, etc.). The output apparatus 1006 is an output device for allowing sending output to the outside (for example, a display, a speaker, etc.). Note that the input apparatus 1005 and the output apparatus 1006 may be provided in an integrated structure (for example, a touch panel).

In addition, the respective devices such as the processor 1001 and the memory 1002 are connected by a bus 1007 for communicating information. The bus 1007 may be formed with a single bus, or may be formed with buses that vary between the apparatuses.

For example, the radio base station 10 and the user terminal 20 may be structured to include hardware such as an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these hardware.

Note that the terminology used in this description and the terminology that is needed to understand this description may be replaced by other terms that convey the same or similar meanings. For example, “channels” and/or “symbols” may be replaced by “signals” (or “signaling”). Also, “signals” may be “messages.” Furthermore, “component carriers” (CCs) may be referred to as “cells,” “frequency carriers,” “carrier frequencies” and so on.

Also, the radio frame may be comprised of one or more periods (frames) in the time domain. Each of the one or more periods (frames) constituting the radio frame may be referred to as a subframe. Further, the subframe may comprise one or more slots in the time domain. Further, the slot may be comprised of one or more symbols (OFDM symbol, SC-FDMA symbol, etc.) in the time domain.

The radio frame, subframe, slot and symbol all represent time units for signal communication. Different designations corresponding to the respective radio frames, subframes, slots and symbols may be used. For example, one subframe may be referred to as a transmission time interval (TTI) multiple consecutive subframes may be referred to as TTIs one slot may be referred to as a TTI. That is, a subframe or TTI may be a subframe in existing LTE (one ms), a period shorter than one ms (for example, 1-13 symbols), or one ins, for example.

Here, the TTI refers to the minimum time unit of scheduling, for example, in wireless communication. For example, in the LTE system, the radio base station performs scheduling for allocating radio resources (such as the frequency bandwidth and transmission power that can be used in each user terminal) to each user terminal in TTI units. The definition of TTI is not limited to this.

A TTI having a time duration of one ms is a TTI having a time duration of one ms, which includes “normal TTI” (TTI in LTE-Rel. 8-12), “normal TTI,” “long TTI,” “normal subframe,” “normal subframe” or “long subframe” or the like. The TTI shorter than the normal TTI may be referred to as “shortened TTI,” “short TTI,” “shortened subframe,” or “short subframe”.

The resource block (RB) is a time domain and frequency domain resource assignment unit and may include one or a plurality of consecutive subcarriers in the frequency domain. Also, the RB may include one or more symbols in the time domain and may be one slot, one subframe, or one TTI in length. 1 TTI, 1 subframe each may be comprised of one or more resource blocks. Note that, the RB may be referred to as “physical resource block (PRB),” “PRB pair,” “RB pair,” and the like.

Further, the resource block may be comprised of one or more resource elements (RE). For example, 1 RE may be a radio resource area of one subcarrier and one symbol.

Note that the structures of the radio frame, the subframe, the slot, the symbol and the like described above are merely examples. For example, the configuration of A, B, C etc. can be variously changed. *A, B, C: the number of subframes included in the radio frame, the number of slots included in the subframe, the number of symbols and RBs included in the slot, the number of subcarriers included in the RB, number of symbols in TTI, symbol duration, cyclic prefix (CP) length, etc.

Also, the information and parameters described in this description may be represented in absolute values or in relative values with respect to a predetermined value, or may be represented in other information formats. For example, radio resources may be specified by predetermined indices.

The information, signals and/or others described in this description may be represented by using a variety of different technologies. For example, data, instructions, commands, information, signals, bits, symbols and chips, all of which may be referenced throughout the description, may be represented by voltages, currents, electromagnetic waves, magnetic fields or particles, optical fields or photons, or any combination of these.

Also, software and commands may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation and microwaves), these wired technologies and/or wireless technologies are also included in the definition of communication media.

Further, the radio base station in this specification may be read as a user terminal. For example, each aspect/embodiment of the present invention may be applied to a configuration in which communication between a radio base station and a user terminal is replaced by communication of a plurality of user terminals (D2D: Device-to-Device). In this case, the user terminal 20 may have the functions of the radio base station 10 described above. In addition, wording such as “up” and “down” may be read as “side”. For example, the uplink channel may be read as a side channel.

Likewise, the user terminal in this specification may be read by a radio base station. In this case, the radio base station 10 may have the function of the user terminal 20 described above.

The example s/embodiments illustrated in this description may be used individually or in combinations, and the mode of may be switched depending on the implementation. Also, a report of predetermined information (for example, a report to the effect that “X holds”) does not necessarily have to be sent explicitly, and can be sent implicitly (by, for example, not reporting this piece of information).

Reporting of information is by no means limited to the example s/embodiments described in this description, and other methods may be used as well. For example, reporting of information may be implemented by using physical layer signaling (for example, DCI (Downlink Control Information) and UCI (Uplink Control Information)), higher layer signaling (for example, RRC (Radio Resource Control) signaling, broadcast information (MIBs (Master Information Blocks) and SIBs (System Information Blocks) and MAC (Medium Access Control) signaling and so on), other signals or combinations of these. Also, RRC signaling may be referred to as “RRC messages,” and can be, for example, an RRC connection setup message, RRC connection reconfiguration message, and so on. Also, the MAC signaling may be reported, for example, by a MAC control element (MAC CE (Control Element)).

The examples/embodiments illustrated in this description may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), CDMA 2000, UMB (Ultra Mobile Broadband), IEEE 802.11 (Wi-Fi (registered trademark)), IEEE 802.16 (WiMAX (registered trademark)), IEEE 802.20. UWB (Ultra-WideBand), Bluetooth (registered trademark), and other adequate systems, and/or next-generation systems that are enhanced based on these.

The order of processes, sequences, flowcharts and so on that have been used to describe the examples/embodiments herein may be re-ordered as long as inconsistencies do not arise. For example, although various methods have been illustrated in this description with various components of steps in exemplary orders, the specific orders that illustrated herein are by no means limiting.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2015-255284, filed on Dec. 25, 2015, including the specification, drawings and abstract, is incorporated herein by reference in its entirety.

1. A user terminal in a cell in which listening is performed before transmission, the user terminal comprising:
a transmission section that transmits channel state information (CSI); and
a measurement section that measures the CSI in a measurement subframe by using a measurement reference signal,
wherein the measurement subframe is defined as a subframe in which the CSI can be measured and is at least one of a Multimedia Broadcast Multicast Service (MBMS) Single Frequency Network (MBSFN) subframe, a partial subframe consisting of part of symbols, and a transmission subframe of a detection signal, other than subframe index #0 or #5, which coincides with a transmission subframe of a channel state information reference signal (CSI-RS).

2. The user terminal according to claim 1, wherein:
the measurement reference signal is a CRS; and
the measurement subframe is a nearest subframe that, a predetermined time or more before a transmission subframe of the CRS, satisfies a condition that there is downlink transmission in the cell and a scrambling sequence of the CRS follows an actual subframe index.

3. The user terminal according to claim 1, wherein:
the measurement reference signal is a CSI-RS; and
the measurement subframe is a nearest subframe that, a predetermined time or more before a transmission subframe of the CSI, satisfies a condition that there is downlink transmission in the cell, transmission of the CSI-RS is configured and the measurement subframe is not a partial subframe.

4. The user terminal according to claim 1, wherein the transmission section transmits capability information indicating whether the CSI can be measured in the measurement subframe.

5. The user terminal according to claim 1, further comprising a receiving section that receives indication information that indicates whether to measure the CSI in the measurement subframe.

6. A radio base station that forms a cell in which listening is performed before transmission, the radio base station comprising:
a transmission section that transmits a measurement reference signal, which a user terminal in the cell uses to measure channel state information (CSI) in a measurement subframe in; and
a control section that controls transmission of the measurement reference signal,
wherein the measurement subframe is defined as a subframe in which the CSI can be measured and is at least one of a Multimedia Broadcast Multicast Service (MBMS) Single Frequency Network (MBSFN) subframe, a partial subframe consisting of part of symbols, and a transmission subframe of a detection signal, other than subframe index #0 or #5, which coincides with a transmission subframe of a channel state information reference signal (CSI-RS).

7. The radio base station according to claim 6, wherein:
the transmission section transmits the measurement reference signal, without transmitting a downlink shared channel, in a time duration of one ms or less; and
the control section performs listening shorter than a predetermined time before the measurement reference signal is transmitted.

8. The radio base station according to claim 6, wherein the control section performs control so that the measurement reference signal is transmitted in an additional symbol added after the partial subframe provided at an end of a transmission burst.

9. The radio base station according to claim 8, wherein the transmission section transmits information related to transmission of the measurement reference signal in the additional symbol to the user terminal.

10. A radio commutation method for a user terminal in a cell in which listening is performed before transmission, the radio communication method comprising the steps of:
transmitting channel state information (CSI); and
measuring the CSI in a measurement subframe by using a measurement reference signal,
wherein the measurement subframe is defined as a subframe in which the CSI can be measured and is at least one of a Multimedia Broadcast Multicast Service (MBMS) Single Frequency Network (MBSFN) subframe, a partial subframe consisting of part of symbols, and a transmission subframe of a detection signal, other than subframe index #0 or #5, which coincides with a transmission subframe of a channel state information reference signal (CSI-RS).

11. The user terminal according to claim 2, wherein the transmission section transmits capability information indicating whether the CSI can be measured in the measurement subframe.

12. The user terminal according to claim 2, further comprising a receiving section that receives indication information that indicates whether to measure the CSI in the measurement subframe.

13. The user terminal according to claim 3, wherein the transmission section transmits capability information indicating whether the CSI can be measured in the measurement subframe.

14. The user terminal according to claim 3, further comprising a receiving section that receives indication information that indicates whether to measure the CSI in the measurement subframe.

15. The radio base station according to claim 7, wherein the control section performs control so that the measurement reference signal is transmitted in an additional symbol added after the partial subframe provided at an end of a transmission burst.
